(19) United States
(12) Patent Application Publication
(10) Pub. No.: US 2024/0383751 A1
(43) Pub. Date: Nov. 21, 2024

(54) INTEGRATED PROCESS AND CATALYSTS FOR MANUFACTURING HYDROGEN IODIDE FROM HYDROGEN AND IODINE

(71) Applicant: Honeywell International Inc., Charlotte, NC (US)

(72) Inventors: Christian Jungong, Depew, NY (US); Haluk Kopkalli, Staten Island, NY (US); Haiyou Wang, Amherst, NY (US); Terris Yang, East Amherst, NY (US); John Quianjun Chen, Charlotte, NC (US)

(21) Appl. No.: 18/570,430

(22) PCT Filed: Jul. 11, 2022
(86) PCT No.: PCT/US2022/073601

§ 371 Date: Dec. 14, 2023

Related U.S. Application Data
(60) Provisional application No. 63/222,794, filed on Jul. 16, 2021.

(51) Int. Cl. C01B 7/13; B01J 21/04; B01J 23/755; B01J 35/45; B01J 37/22; B01J 38/00

(52) U.S. Cl. CPC C01B 7/135; B01J 21/04; B01J 23/755; B01J 35/45; B01J 37/22; B01J 38/00

(57) ABSTRACT

The present invention provides a process for producing hydrogen iodide. The process includes providing a vapor-phase reactant stream comprising hydrogen and iodine and reacting the reactant stream in the presence of a catalyst to produce a product stream comprising hydrogen iodide. The catalyst includes at least one selected from the group of nickel, cobalt, cobalt halides, iron, nickel oxide, nickel halides, copper, copper oxide, copper halides, cobalt oxide, ferrous chloride, ferric chloride, iron oxide, zinc, zinc oxide, zinc halides, molybdenum, tungsten, magnesium, magnesium oxide, and magnesium halides. The catalyst is supported on a support.

### CROSS-REFERENCE TO RELATED APPLICATION

This application claims priority to Provisional Application No. 63/222,794, filed Jul. 16, 2021, which is herein incorporated by reference in its entirety.

### FIELD

The present disclosure relates to a process for producing hydrogen iodide. Specifically, the present disclosure relates to a process for producing anhydrous hydrogen iodide from hydrogen and iodine in the presence of a catalyst.

### BACKGROUND

Hydrogen iodide is an important industrial chemical used as a reducing agent, as well as in the preparation of hydroiodic acid, organic and inorganic iodides, iodoalkanes. However, hydrogen iodide is very difficult to handle due to its instability and reactivity. For example, hydrogen iodide decomposes in the presence of heat or light to form hydrogen and iodine. Additionally, in the presence of moisture, hydrogen iodide forms hydroiodic acid which can corrode most metals. The instability and reactivity of hydrogen iodide makes it hard to store and to transport. As such, anhydrous hydrogen iodide is often prepared locally for immediate use.

Various methods have been reported for making hydrogen iodide. See, for example, N. N. Greenwood et al., The Chemistry of the Elements, 2nd edition, Oxford: Butterworth-Heineman. p 809-815, 1997, in which hydrogen iodide is prepared from the reaction of elemental iodine with hydrazine according to Equation 1 below:

$$2 {I}_{2} + {N}_{2} {H}_{4} \to 4 HI + {N}_{2} . \qquad Eq . 1$$

In another example, in Textbook of Practical Organic Chemistry, 3^{rd} edition, A. I. Vogel teaches that hydrogen iodide can be prepared by reacting a stream of hydrogen sulfide with iodine according to Equation 2 below:

$${H}_{2} S + {I}_{2} ⇒ 2 H I + S . \qquad Eq . 2$$

Each of the above examples use costly starting materials, such as hydrogen sulfide or hydrazine, that restrict their application for large scale, economical preparation of hydrogen iodide. Additionally, the use of hydrazine for preparation of hydrogen iodide results in the formation of nitrogen gas as a byproduct. Separation of the nitrogen gas from the hydrogen iodide to purify the hydrogen iodide is difficult and expensive, thus adding to manufacturing costs. Similarly, the use of hydrogen sulfide results in the formation of sulfur, which is difficult to separate from unreacted iodine, again adding to manufacturing costs. Sulfur may poison any catalysts used, further adding to manufacturing costs.

In some other examples, hydrogen iodide is prepared from elemental iodine and hydrogen gas, according to Equation 3 below:

$${H}_{2} + {I}_{2} ⇒ 2 H I . \qquad Eq . 3$$

Such examples can more easily produce high-purity hydrogen iodide as no nitrogen or sulfur is produced. For instance, JP4713895B2 demonstrates the preparation of hydrogen iodide in the gas phase using hydrogen gas and iodine vapor, catalyzed by noble metal-based catalysts. Specifically, the disclosed reaction can be catalyzed by platinum, rhodium, palladium, and ruthenium supported on metal oxides selected from magnesium oxide, titanium oxide, silica oxide, alumina and zirconia. However, the use of noble metal-based catalysts for preparation of hydrogen iodide would further increase manufacturing costs due to the generally high cost of noble metals. Thus, there is need for alternative metal catalysts that do not contain a noble metal for catalyzing the reaction of hydrogen and iodine to make hydrogen iodide.

### SUMMARY

The present disclosure provides an integrated process for the manufacture of hydrogen iodide (HI) from hydrogen (H₂) and elemental iodine (I₂) that includes the use of a catalyst including at least one selected from the group of nickel, nickel oxide, nickel halides, cobalt, cobalt oxide, cobalt halides, iron, iron oxide, iron halides, copper, copper oxide, copper halides, zinc, zinc oxide, zinc halides, molybdenum, tungsten, magnesium, magnesium oxide, and magnesium halides supported on a support.

In one embodiment, the present disclosure provides a process for producing hydrogen iodide including providing a vapor-phase reactant stream comprising hydrogen and iodine; and reacting the reactant stream in the presence of a nickel iodide catalyst supported on a support to produce a product stream comprising hydrogen iodide.

In another embodiment, the present disclosure provides a process for regenerating a catalyst including providing a catalyst selected from the group consisting of: nickel, nickel oxide, nickel halides, cobalt, cobalt oxide, cobalt halides, iron, iron oxide, iron halides, copper, copper oxide, copper halides, zinc, zinc oxide, zinc halides, molybdenum, tungsten, magnesium, magnesium oxide, and magnesium halides, wherein the catalyst is supported on a support and is configured to convert hydrogen and iodine into hydrogen iodide; drying the catalyst; reducing the catalyst a first time; oxidizing the catalyst a first time; and reducing the catalyst a second time, wherein the process generates a regenerated catalyst with an average particle size less than 800 Å.

In another embodiment, the present disclosure provides a process for producing hydrogen iodide including providing a vapor-phase reactant stream comprising hydrogen and iodine; and reacting the reactant stream in the presence of a catalyst to produce a product stream comprising hydrogen iodide, wherein the catalyst comprises at least one selected from the group of nickel, nickel oxide, nickel halides, cobalt, cobalt oxide, cobalt halides, iron, iron oxide, iron halides, copper, copper oxide, copper halides, zinc, zinc oxide, zinc halides, molybdenum, tungsten, magnesium, magnesium oxide, and magnesium halides, and wherein the catalyst is supported on a support.

In another embodiment, the present disclosure provides a process for producing hydrogen iodide. The process includes the steps of reacting hydrogen and iodine in the vapor phase in the presence of a catalyst to produce a product stream comprising hydrogen iodide and unreacted iodine, removing at least some of the unreacted iodine from the product stream by cooling the product stream to form solid iodine, producing liquid iodine from the solid iodine, and recycling the liquified iodine to the reacting step. The solid iodine forms in a first iodine removal vessel or a second iodine removal vessel. The liquid iodine is produced from the solid iodine by heating the first iodine removal vessel to liquefy the solid iodine when cooling the product stream through the second iodine removal vessel or heating the second iodine removal vessel to liquefy the solid iodine when cooling the product stream through the first iodine removal vessel. The catalyst includes at least one selected from the group of nickel, nickel oxide, nickel halides, cobalt, cobalt oxide, cobalt halides, iron, iron oxide, iron halides, copper, copper oxide, copper halides, zinc, zinc oxide, zinc halides, magnesium, magnesium oxide, molybdenum, tungsten, and magnesium halides. The catalyst is supported on a support.

### BRIEF DESCRIPTION OF THE DRAWINGS

FIG. 1 is a process flow diagram showing an integrated process for manufacturing anhydrous hydrogen iodide.

FIG. 2 is a process flow diagram showing another integrated process for manufacturing anhydrous hydrogen iodide.

FIG. 3 is a plot of equilibrium concentrations of nickel species at different temperatures.

FIG. 4 is a schematic of a catalyst regeneration process in accordance with Example 3.

FIG. 5 is a plot of iodine conversion as a function of temperature in accordance with Example 4.

### DETAILED DESCRIPTION

The present disclosure provides an integrated process for the manufacture of anhydrous hydrogen iodide (HI) from hydrogen (H₂) and elemental iodine (I₂) that includes the use of at least one catalyst selected from the group of nickel, nickel oxide, nickel halides, cobalt, cobalt oxide, cobalt halides, iron, iron oxide, iron halides, copper, copper oxide, copper halides, zinc, zinc oxide, zinc halides, molybdenum, tungsten magnesium oxide, and magnesium halides supported on a support. It has been found that the use of such a catalyst provides for the efficient manufacture of hydrogen iodide on a commercial scale. The efficiency of the manufacture of the hydrogen iodide is further enhanced by the recycling of the reactants. Recycling of elemental iodine is particularly important because it is an expensive raw material with a bulk price of about $20 to $100 per kilogram. However, recycling iodine presents challenges because it is a solid below 113.7° C. The present disclosure also provides integrated processes for the manufacture of hydrogen iodide that include recycling of iodine in an efficient and continuous manner.

As disclosed herein, the anhydrous hydrogen iodide is produced from a reactant stream comprising hydrogen (H₂) and iodine (I₂). The reactant stream may consist essentially of hydrogen, iodine and recycled hydrogen iodide. The reactant stream may consist of hydrogen, iodine and hydrogen iodide.

The term “anhydrous hydrogen iodide” means hydrogen iodide that is substantially free of water. That is, any water in the anhydrous hydrogen iodide is in an amount by weight less that about 500 ppm, about 300 ppm, about 200 ppm, about 100 ppm, about 50 ppm, about 30 ppm, about 20 ppm, about 10 ppm, about 5 ppm, about 3 ppm, about 2 ppm, or about 1 ppm, or less than any value defined between any two of the foregoing values. Preferably, the anhydrous hydrogen iodide comprises water by weight in an amount less than about 100 ppm. More preferably, the anhydrous hydrogen iodide comprises water by weight in an amount less than about 10 ppm. Most preferably, the anhydrous hydrogen iodide comprises water by weight in an amount less than about 1 ppm.

It is preferred that there be as little water in the reactant stream as possible because the presence of moisture results in the formation of hydroiodic acid, which is corrosive and can be detrimental to downstream equipment and process lines. In addition, recovery of the hydrogen iodide from the hydroiodic acid adds to the manufacturing costs.

The hydrogen is substantially free of water, including any water by weight in an amount less than about 500 ppm, about 300 ppm, about 200 ppm, about 100 ppm, about 50 ppm, about 30 ppm, about 20 ppm, 10 ppm, or about 5 ppm, or less than any value defined between any two of the foregoing values. Preferably, the hydrogen comprises any water by weight in an amount less than about 50 ppm. More preferably, the hydrogen comprises any water by weight in an amount less than about 10 ppm. Most preferably, the hydrogen comprises any water by weight in an amount less than about 5 ppm.

The hydrogen is substantially free of oxygen. That is, any oxygen in the hydrogen is in an amount by weight less than about 500 parts per million, about 300 ppm, about 200 ppm, about 100 ppm, about 50 ppm, about 30 ppm, about 20 ppm, about 10 ppm, about 5 ppm, about 3 ppm, about 2 ppm, or about 1 ppm, or less than any value defined between any two of the foregoing values. Preferably, the amount of oxygen by weight in the hydrogen is less than about 100 ppm. More preferably, the amount of oxygen by weight in the hydrogen is less than about 10 ppm. Most preferably, the amount of oxygen by weight in the hydrogen is less than about 1 ppm. It is preferred that there be as little oxygen in the hydrogen as possible because the oxygen can react with the hydrogen to form water.

The iodine is also substantially free of water, including any water by weight in an amount less than about 3000 ppm, about 2000 ppm, about 1000 ppm, about 500 ppm, about 300 ppm, about 200 ppm, about 100 ppm, about 50 ppm, about 30 ppm, about 20 ppm, or about 10 ppm, or less than any value defined between any two of the foregoing values. Preferably, the iodine comprises any water by weight in an amount less than about 100 ppm. More preferably, the iodine comprises any water by weight in an amount less than about 30 ppm. Most preferably, the iodine comprises any water by weight in an amount less than about 10 ppm.

Elemental iodine in solid form is commercially available from, for example, SQM, Santiago, Chile, or Kanto Natural Gas Development Co., Ltd, Chiba, Japan. Hydrogen in compressed gas form is commercially available from, for example, Airgas, Radnor, PA, or from Air Products and Chemicals, Inc., Allentown, PA.

In the reactant stream, the mole ratio of hydrogen to iodine may be as low as about 1:1, about 1.5:1, about 2:1, about 2.5:1, about 2.7:1, or about 3:1, or as high as about 4:1, about 5:1, about 6:1, about 7:1, about 8:1, about 9:1, or about 10:1, or within any range defined between any two of the foregoing values, such as about 1:1 to about 10:1, about 2:1 to about 8:1, about 3:1 to about 6:1, about 2:1 to about 5:1, about 2:1 to about 3:1, about 2.5:1 to about 3:1, or about 2.7:1 to about 3.0:1, for example. Preferably, the mole ratio of hydrogen to iodine is from about 2:1 to about 9:1. More preferably, the mole ratio of hydrogen to iodine is from about 2.5:1 to about 8:1. Most preferably, the mole ratio of hydrogen to iodine is from about 2.5:1 to 6:1.

The reactant stream reacts in the presence of a catalyst contained within a reactor to produce a product stream comprising anhydrous hydrogen iodide according to Equation 3 above. The reactor may be a heated tube reactor, such as a fixed bed tubular reactor, including a tube containing the catalyst. The tube may be made of a metal such as stainless steel, nickel, and/or a nickel alloy, such as a nickel-chromium alloy, a nickel-molybdenum alloy, a nickel-chromium-molybdenum alloy, a nickel-iron-chromium alloy, or a nickel-copper alloy. The tube reactor may be heated, thus also heating the catalyst. The feed materials may be preheated before entering the reactor. Alternatively, the reactor may be any type of packed reactor, such as a multi-tubular reactor (e.g. a shell-and-tube reactor) in which the catalyst is packed into the tubes and with a heat transfer medium in contact with the outside of the tubes, for example. The reactor may operate isothermally or adiabatically.

As noted above, the catalyst is at least one selected from the group of nickel, nickel oxide, nickel halide, cobalt, cobalt oxide, cobalt halides, iron, iron oxide, iron halide, copper, copper oxide, copper halides, zinc, zinc oxide, zinc halides, molybdenum, tungsten, magnesium, magnesium oxide, and/or magnesium halides catalyst on a support. Thus, the catalyst comprises at least one selected from the group of nickel, nickel oxide, nickel halides, cobalt, cobalt oxide, cobalt halides, iron, iron oxide, iron halides, copper, copper oxide, copper halides, zinc, zinc oxide, zinc halides, molybdenum, tungsten, magnesium, magnesium oxide, and magnesium halides, wherein the catalyst is supported on a support. As used herein, “halides” refers to fluorides, chlorides, bromides, and iodides. The catalyst may also comprise a promoter, which may be selected from the group of catalysts mentioned above. For example, zinc, zinc oxide, zinc halides, magnesium, magnesium oxides, magnesium halides, and/or combinations thereof may be used as a promoter. As another example, potassium salts may be used as a promoter.

The catalyst may comprise a combination of elements or compounds, such as Ni/Co, Ni/Fe, Co/Fe, Ni/Mo, and Ni/W. The presence of multiple metals, such as the addition of Co, Fe, Mo, and/or W may improve dispersion of the catalyst on the support, and may reduce sintering.

The catalyst may be supplied in a passivated form and may then be activated. Additionally, the catalyst may be converted from one species to another over the course of the reaction. For example, metallic nickel on a support may be converted in situ into nickel iodide (NiI₂). Metallic nickel supported on inert materials are commercially available at various loadings of the nickel metal. When supplied, the nickel supported on inert material is in a passivated form and may need to be activated in hydrogen gas to expose the metallic nickel phase, before iodine vapors are supplied to convert the metallic nickel phase into NiI₂. Alternatively, catalysts that may be prepared in situ like NiI₂ may be supplied in a ready-made form, by preparing the catalyst through impregnating, pore filling, and/or adsorption onto the support.

The catalyst may be deliquescent and when exposed to ambient conditions wherein it may absorb moisture and dissolve in its own water of hydration. Therefore, whether the catalyst is prepared in situ or externally, it may be desired to use the catalyst in anhydrous conditions, as exposure of the catalyst to moisture may result in the formation of a hydrated complex. The formation of hydrated complexes may be associated with significant agglomeration and loss of catalytic activity. The deactivated catalyst may be regenerated by drying in hot inert gas, followed by repeated cycles of reduction in hydrogen gas and oxidation in oxygen

The catalyst may also be regenerated after being used for a period of time. Regenerating the catalyst may reduce catalyst particle size and may increase catalytic activity compared to spent and/or agglomerated catalyst. For example, a fresh catalyst may have a first particle size, and a spent catalyst may have a second particle size larger than the first particle size. The spent catalyst may also agglomerate when exposed to ambient conditions forming a third particle size larger than the second particle size. The agglomerated catalyst may be dried and chemically reduced to reduce the particle size and increase catalytic activity. The catalyst may undergo multiple rounds of reduction, oxidation, and drying to further reduce particle size and/or increase catalytic activity, thereby making a regenerated catalyst with a fourth particle size. The reduction may be carried out with hydrogen gas, and the oxidation may be carried out with oxygen gas. Other reducing agents may include, but are not limited to, carbon monoxide (CO), ammonia (NH₃), and methane (CH₄).

The first particle size may be less than 400 Å, less than 300 Å, less than 250 Å, less than 200 Å, less than 150 Å, less than 100 Å, less than 75 Å, less than 50 Å, or any range including any two of these values as endpoints. The second particle size (spent or deactivated catalyst) may be less than 800 Å, less than 700 Å, less than 650 Å, less than 600 Å, less than 550 Å, less than 500 Å, less than 450 Å, less than 400 Å, less than 350 Å, less than 300 Å, less than 200 Å, or any range including any two of these values as endpoints. The third particle size (agglomerated catalyst) may have a particle size greater than 500 Å, greater than 550 Å, greater than 600 Å, greater than 650 Å, greater than 700 Å, greater than 750 Å, greater than 800 Å, greater than 850 Å, greater than 900 Å, greater than 950 Å, greater than 1000 Å, greater than 1100 Å, greater than 1200 Å, greater than 1300 Å, greater than 1500 Å, or any range including any two of these values as endpoints. The fourth particle size (regenerated catalyst) may be less than 500 Å, less than 400 Å, less than 300 Å, less than 250 Å, less than 200 Å, less than 150 Å, less than 100 Å, less than 75 Å, less than 50 Å, or any range including any two of these values as endpoints. Particle sizes may be measured by X-Ray diffraction (XRD).

Without wishing to be bound to theory, the present inventors believe that successive reduction and oxidation of supported catalysts may result in the formation of pitted particles and redispersion on the support. In principle, oxidation of metallic catalysts may result in the formation of pitted particles. The pits on the particle surface may coalesce to form cavities. The cavities may grow leading to fragmentation of the particles into smaller ones and spreading of the oxidized particles over the support. Formation of cavities on particles and dispersion on the support relate closely to enhanced interactions between the catalyst and support during the oxidation. Although oxidation and reduction can be attained as several different conditions, redispersion on the support may occur under critical conditions. During reduction (such as in hydrogen gas), long heating times lead to sintering resulting in the formation of large particles. In addition, reduction temperatures greater than 400° C. may also promote sintering.

The support can be selected from the group of activated carbon, silica gel, silica-alumina, zeolite, silicon carbide, metal oxides, and combinations thereof. Non-exclusive examples of the metal oxides include alumina, magnesium oxide, titanium oxide, zinc oxide, zirconia, chromia, and combinations thereof. Non-exclusive examples of zeolites include 3A, 4A, 5A, XH-9, 13X, and combinations thereof.

The catalyst can comprise nickel on a silica gel support. The catalyst can comprise nickel on a silica-alumina support. The catalyst can comprise nickel on a zeolite support. The catalyst can comprise nickel on an activated carbon support. The catalyst can comprise nickel on a silicon carbide support. The catalyst can consist essentially of nickel on a silica gel support. The catalyst can consist essentially of nickel on a silica-alumina support. The catalyst can consist essentially of nickel on a zeolite support. The catalyst can consist essentially of nickel on an activated carbon support. The catalyst can consist essentially of nickel on a silicon carbide support. The catalyst can consist of nickel on a silica gel support. The catalyst can consist of nickel on a silica-alumina support. The catalyst can consist of nickel on a zeolite support. The catalyst can consist of nickel on an activated carbon support. The catalyst can consist of nickel on a silicon carbide support.

The catalyst can comprise nickel on a metal oxide support. The catalyst can consist essentially of nickel on a metal oxide support. The catalyst can consist of nickel on a metal oxide support. The catalyst can comprise nickel on an alumina support. The catalyst can comprise nickel on a magnesium oxide support. The catalyst can comprise nickel on a titanium oxide support. The catalyst can comprise nickel on a zinc oxide support. The catalyst can comprise nickel on a zirconia support. The catalyst can comprise nickel on a chromia support. The catalyst can consist essentially of nickel on an alumina support. The catalyst can consist essentially of nickel on a magnesium oxide support. The catalyst can consist essentially of nickel on a titanium oxide support. The catalyst can consist essentially of nickel on a zinc oxide support. The catalyst can consist essentially of nickel on a zirconia support. The catalyst can consist essentially of nickel on a chromia support. The catalyst can consist of nickel on an alumina support. The catalyst can consist of nickel on a magnesium oxide support. The catalyst can consist of nickel on a titanium oxide support. The catalyst can consist of nickel on a zinc oxide support. The catalyst can consist of nickel on a zirconia support. The catalyst can consist of nickel on a chromia support.

The catalyst can comprise nickel iodide on a silica gel support. The catalyst can comprise nickel iodide on a silica-alumina support. The catalyst can comprise nickel iodide on a zeolite support. The catalyst can comprise nickel iodide on an activated carbon support. The catalyst can comprise nickel iodide on a silicon carbide support. The catalyst can consist essentially of nickel iodide on a silica gel support. The catalyst can consist essentially of nickel iodide on a silica-alumina support. The catalyst can consist essentially of nickel iodide on a zeolite support. The catalyst can consist essentially of nickel iodide on an activated carbon support. The catalyst can consist essentially of nickel iodide on a silicon carbide support. The catalyst can consist of nickel iodide on a silica gel support. The catalyst can consist of nickel iodide on a silica-alumina support. The catalyst can consist of nickel iodide on a zeolite support. The catalyst can consist of nickel iodide on an activated carbon support. The catalyst can consist of nickel iodide on a silicon carbide support.

The catalyst can comprise nickel iodide on a metal oxide support. The catalyst can consist essentially of nickel iodide on a metal oxide support. The catalyst can consist of nickel iodide on a metal oxide support. The catalyst can comprise nickel iodide on an alumina support. The catalyst can comprise nickel iodide on a magnesium oxide support. The catalyst can comprise nickel iodide on a titanium oxide support. The catalyst can comprise nickel iodide on a zinc oxide support. The catalyst can comprise nickel iodide on a zirconia support. The catalyst can comprise nickel iodide on a chromia support. The catalyst can consist essentially of nickel iodide on an alumina support. The catalyst can consist essentially of nickel iodide on a magnesium oxide support. The catalyst can consist essentially of nickel iodide on a titanium oxide support. The catalyst can consist essentially of nickel iodide on a zinc oxide support. The catalyst can consist essentially of nickel iodide on a zirconia support. The catalyst can consist essentially of nickel iodide on a chromia support. The catalyst can consist of nickel iodide on an alumina support. The catalyst can consist of nickel iodide on a magnesium oxide support. The catalyst can consist of nickel iodide on a zinc oxide support. The catalyst can consist of nickel iodide on a zirconia support. The catalyst can consist of nickel iodide on a chromia support.

The catalyst can comprise nickel oxide on a silica gel support. The catalyst can comprise nickel oxide on a silica-alumina support. The catalyst can comprise nickel oxide on a zeolite support. The catalyst can comprise nickel oxide on an activated carbon support. The catalyst can comprise nickel oxide on a silicon carbide support. The catalyst can consist essentially of nickel oxide on a silica gel support. The catalyst can consist essentially of nickel oxide on a silica-alumina support. The catalyst can consist essentially of nickel oxide on a zeolite support. The catalyst can consist essentially of nickel oxide on an activated carbon support. The catalyst can consist essentially of nickel oxide on a silicon carbide support. The catalyst can consist of nickel oxide on a silica gel support. The catalyst can consist of nickel oxide on a silica-alumina support. The catalyst can consist of nickel oxide on a zeolite support. The catalyst can consist of nickel oxide on an activated carbon support. The catalyst can consist of nickel oxide on a silicon carbide support.

The catalyst can comprise nickel oxide on a metal oxide support. The catalyst can consist essentially of nickel oxide on a metal oxide support. The catalyst can consist of nickel oxide on a metal oxide support. The catalyst can comprise nickel oxide on an alumina support. The catalyst can comprise nickel oxide on a magnesium oxide support. The catalyst can comprise nickel oxide on a titanium oxide support. The catalyst can comprise nickel oxide on a zinc oxide support. The catalyst can comprise nickel oxide on a zirconia support. The catalyst can comprise nickel oxide on a chromia support. The catalyst can consist essentially of nickel oxide on an alumina support. The catalyst can consist essentially of nickel oxide on a magnesium oxide support. The catalyst can consist essentially of nickel oxide on a titanium oxide support. The catalyst can consist essentially of nickel oxide on a zinc oxide support. The catalyst can consist essentially of nickel oxide on a zirconia support. The catalyst can consist essentially of nickel oxide on a chromia support. The catalyst can consist of nickel oxide on an alumina support. The catalyst can consist of nickel oxide on a magnesium oxide support. The catalyst can consist of nickel oxide on a titanium oxide support. The catalyst can consist of nickel oxide on a zinc oxide support. The catalyst can consist of nickel oxide on a zirconia support. The catalyst can consist of nickel oxide on a chromia support.

The catalyst can comprise nickel and nickel oxide on a silica gel support. The catalyst can comprise nickel and nickel oxide on a silica-alumina support. The catalyst can comprise nickel and nickel oxide on a zeolite support. The catalyst can comprise nickel and nickel oxide on an activated carbon support. The catalyst can comprise nickel and nickel oxide on a silicon carbide support. The catalyst can consist essentially of nickel and nickel oxide on a silica gel support. The catalyst can consist essentially of nickel and nickel oxide on a silica-alumina support. The catalyst can consist essentially of nickel and nickel oxide on a zeolite support. The catalyst can consist essentially of nickel and nickel oxide on an activated carbon support. The catalyst can consist essentially of nickel and nickel oxide on a silicon carbide support. The catalyst can consist of nickel and nickel oxide on a silica gel support. The catalyst can consist of nickel and nickel oxide on a silica-alumina support. The catalyst can consist of nickel and nickel oxide on a zeolite support. The catalyst can consist of nickel and nickel oxide on an activated carbon support. The catalyst can consist of nickel and nickel oxide on a silicon carbide support.

The catalyst can comprise nickel and nickel oxide on a metal oxide support. The catalyst can consist essentially of nickel and nickel oxide on a metal oxide support. The catalyst can consist of nickel and nickel oxide on a metal oxide support. The catalyst can comprise nickel and nickel oxide on an alumina support. The catalyst can comprise nickel and nickel oxide on a magnesium oxide support. The catalyst can comprise nickel and nickel oxide on a titanium oxide support. The catalyst can comprise nickel and nickel oxide on a zinc oxide support. The catalyst can comprise nickel and nickel oxide on a zirconia support. The catalyst can comprise nickel and nickel oxide on a chromia support. The catalyst can consist essentially of nickel and nickel oxide on an alumina support. The catalyst can consist essentially of nickel and nickel oxide on a magnesium oxide support. The catalyst can consist essentially of nickel and nickel oxide on a titanium oxide support. The catalyst can consist essentially of nickel and nickel oxide on a zinc oxide support. The catalyst can consist essentially of nickel and nickel oxide on a zirconia support. The catalyst can consist essentially of nickel and nickel oxide on a chromia support. The catalyst can consist of nickel and nickel oxide on an alumina support. The catalyst can consist of nickel and nickel oxide on a magnesium oxide support. The catalyst can consist of nickel and nickel oxide on a titanium oxide support. The catalyst can consist of nickel and nickel oxide on a zinc oxide support. The catalyst can consist of nickel and nickel oxide on a zirconia support. The catalyst can consist of nickel and nickel oxide on a chromia support.

The catalyst can comprise cobalt on a silica gel support. The catalyst can comprise cobalt on a silica-alumina support. The catalyst can comprise cobalt on a zeolite support. The catalyst can comprise cobalt on an activated carbon support. The catalyst can comprise cobalt on a silicon carbide support. The catalyst can consist essentially of cobalt on a silica gel support. The catalyst can consist essentially of cobalt on a silica-alumina support. The catalyst can consist essentially of cobalt on a zeolite support. The catalyst can consist essentially of cobalt on an activated carbon support. The catalyst can consist essentially of cobalt on a silicon carbide support. The catalyst can consist of cobalt on a silica gel support. The catalyst can consist of cobalt on a silica-alumina support. The catalyst can consist of cobalt on a zeolite support. The catalyst can consist of cobalt on an activated carbon support. The catalyst can consist of cobalt on a silicon carbide support.

The catalyst can comprise cobalt on a metal oxide support. The catalyst can consist essentially of cobalt on a metal oxide support. The catalyst can consist of cobalt on a metal oxide support. The catalyst can comprise cobalt on an alumina support. The catalyst can comprise cobalt on a magnesium oxide support. The catalyst can comprise cobalt on a titanium oxide support. The catalyst can comprise cobalt on a zinc oxide support. The catalyst can comprise cobalt on a zirconia support. The catalyst can comprise cobalt on a chromia support. The catalyst can consist essentially of cobalt on an alumina support. The catalyst can consist essentially of cobalt on a magnesium oxide support. The catalyst can consist essentially of cobalt on a titanium oxide support. The catalyst can consist essentially of cobalt on a zinc oxide support. The catalyst can consist essentially of cobalt on a zirconia support. The catalyst can consist essentially of cobalt on a chromia support. The catalyst can consist of cobalt on an alumina support. The catalyst can consist of cobalt on a magnesium oxide support. The catalyst can consist of cobalt on a titanium oxide support. The catalyst can consist of cobalt on a zinc oxide support. The catalyst can consist of cobalt on a zirconia support. The catalyst can consist of cobalt on a chromia support.

The catalyst can comprise cobalt oxide on a silica gel support. The catalyst can comprise cobalt oxide on a silica-alumina support. The catalyst can comprise cobalt oxide on a zeolite support. The catalyst can comprise cobalt oxide on an activated carbon support. The catalyst can comprise cobalt oxide on a silicon carbide support. The catalyst can consist essentially of cobalt oxide on a silica gel support. The catalyst can consist essentially of cobalt oxide on a silica-alumina support. The catalyst can consist essentially of cobalt oxide on a zeolite support. The catalyst can consist essentially of cobalt oxide on an activated carbon support. The catalyst can consist essentially of cobalt oxide on a silicon carbide support. The catalyst can consist of cobalt oxide on a silica gel support. The catalyst can consist of cobalt oxide on a silica-alumina support. The catalyst can consist of cobalt oxide on a zeolite support. The catalyst can consist of cobalt oxide on an activated carbon support. The catalyst can consist of cobalt oxide on a silicon carbide support.

The catalyst can comprise cobalt oxide on a metal oxide support. The catalyst can consist essentially of cobalt oxide on a metal oxide support. The catalyst can consist of cobalt oxide on a metal oxide support. The catalyst can comprise cobalt oxide on an alumina support. The catalyst can comprise cobalt oxide on a magnesium oxide support. The catalyst can comprise cobalt oxide on a titanium oxide support. The catalyst can comprise cobalt oxide on a zinc oxide support. The catalyst can comprise cobalt oxide on a zirconia support. The catalyst can comprise cobalt oxide on a chromia support. The catalyst can consist essentially of cobalt oxide on an alumina support. The catalyst can consist essentially of cobalt oxide on a magnesium oxide support. The catalyst can consist essentially of cobalt oxide on a titanium oxide support. The catalyst can consist essentially of cobalt oxide on a zinc oxide support. The catalyst can consist essentially of cobalt oxide on a zirconia support. The catalyst can consist essentially of cobalt oxide on a chromia support. The catalyst can consist of cobalt oxide on an alumina support. The catalyst can consist of cobalt oxide on a magnesium oxide support. The catalyst can consist of cobalt oxide on a titanium oxide support. The catalyst can consist of cobalt oxide on a zinc oxide support. The catalyst can consist of cobalt oxide on a zirconia support. The catalyst can consist of cobalt oxide on a chromia support.

The catalyst can comprise cobalt and cobalt oxide on a silica gel support. The catalyst can comprise cobalt and cobalt oxide on a silica-alumina support. The catalyst can comprise cobalt and cobalt oxide on a zeolite support. The catalyst can comprise cobalt and cobalt oxide on an activated carbon support. The catalyst can comprise cobalt and cobalt oxide on a silicon carbide support. The catalyst can consist essentially of cobalt and cobalt oxide on a silica gel support. The catalyst can consist essentially of cobalt and cobalt oxide on a silica-alumina support. The catalyst can consist essentially of cobalt and cobalt oxide on a zeolite support. The catalyst can consist essentially of cobalt and cobalt oxide on an activated carbon support. The catalyst can consist essentially of cobalt and cobalt oxide on a silicon carbide support. The catalyst can consist of cobalt and cobalt oxide on a silica gel support. The catalyst can consist of cobalt and cobalt oxide on a silica-alumina support. The catalyst can consist of cobalt and cobalt oxide on a zeolite support. The catalyst can consist of cobalt and cobalt oxide on an activated carbon support. The catalyst can consist of cobalt and cobalt oxide on a silicon carbide support.

The catalyst can comprise cobalt and cobalt oxide on a metal oxide support. The catalyst can consist essentially of cobalt and cobalt oxide on a metal oxide support. The catalyst can consist of cobalt and cobalt oxide on a metal oxide support. The catalyst can comprise cobalt and cobalt oxide on an alumina support. The catalyst can comprise cobalt and cobalt oxide on a magnesium oxide support. The catalyst can comprise cobalt and cobalt oxide on a titanium oxide support. The catalyst can comprise cobalt and cobalt oxide on a zinc oxide support. The catalyst can comprise cobalt and cobalt oxide on a zirconia support. The catalyst can comprise cobalt and cobalt oxide on a chromia support. The catalyst can consist essentially of cobalt and cobalt oxide on an alumina support. The catalyst can consist essentially of cobalt and cobalt oxide on a magnesium oxide support. The catalyst can consist essentially of cobalt and cobalt oxide on a titanium oxide support. The catalyst can consist essentially of cobalt and cobalt oxide on a zinc oxide support. The catalyst can consist essentially of cobalt and cobalt oxide on a zirconia support. The catalyst can consist essentially of cobalt and cobalt oxide on a chromia support. The catalyst can consist of cobalt and cobalt oxide on an alumina support. The catalyst can consist of cobalt and cobalt oxide on a magnesium oxide support. The catalyst can consist of cobalt and cobalt oxide on a titanium oxide support. The catalyst can consist of cobalt and cobalt oxide on a zinc oxide support. The catalyst can consist of cobalt and cobalt oxide on a zirconia support. The catalyst can consist of cobalt and cobalt oxide on a chromia support.

The catalyst can comprise iron on a silica gel support. The catalyst can comprise iron on a silica-alumina support. The catalyst can comprise iron on a zeolite support. The catalyst can comprise iron on an activated carbon support. The catalyst can comprise iron on a silicon carbide support. The catalyst can consist essentially of iron on a silica gel support. The catalyst can consist essentially of iron on a silica-alumina support. The catalyst can consist essentially of iron on a zeolite support. The catalyst can consist essentially of iron on an activated carbon support. The catalyst can consist essentially of iron on a silicon carbide support. The catalyst can consist of iron on a silica gel support. The catalyst can consist of iron on a silica-alumina support. The catalyst can consist of iron on a zeolite support. The catalyst can consist of iron on an activated carbon support. The catalyst can consist of iron on a silicon carbide support.

The catalyst can comprise iron on a metal oxide support. The catalyst can consist essentially of iron on a metal oxide support. The catalyst can consist of iron on a metal oxide support. The catalyst can comprise iron on an alumina support. The catalyst can comprise iron on a magnesium oxide support. The catalyst can comprise iron on a titanium oxide support. The catalyst can comprise iron on a zinc oxide support. The catalyst can comprise iron on a zirconia support. The catalyst can comprise iron on a chromia support. The catalyst can consist essentially of iron on an alumina support. The catalyst can consist essentially of iron on a magnesium oxide support. The catalyst can consist essentially of iron on a titanium oxide support. The catalyst can consist essentially of iron on a zinc oxide support. The catalyst can consist essentially of iron on a zirconia support. The catalyst can consist essentially of iron on a chromia support. The catalyst can consist of iron on an alumina support. The catalyst can consist of iron on a magnesium oxide support. The catalyst can consist of iron on a titanium oxide support. The catalyst can consist of iron on a zinc oxide support. The catalyst can consist of iron on a zirconia support. The catalyst can consist of iron on a chromia support.

The catalyst can comprise iron oxide on a silica gel support. The catalyst can comprise iron oxide on a silica-alumina support. The catalyst can comprise iron oxide on a zeolite support. The catalyst can comprise iron oxide on an activated carbon support. The catalyst can comprise iron oxide on a silicon carbide support. The catalyst can consist essentially of iron oxide on a silica gel support. The catalyst can consist essentially of iron oxide on a silica-alumina support. The catalyst can consist essentially of iron oxide on a zeolite support. The catalyst can consist essentially of iron oxide on an activated carbon support. The catalyst can consist essentially of iron oxide on a silicon carbide support. The catalyst can consist of iron oxide on a silica gel support. The catalyst can consist of iron oxide on a silica-alumina support. The catalyst can consist of iron oxide on a zeolite support. The catalyst can consist of iron oxide on an activated carbon support. The catalyst can consist of iron oxide on a silicon carbide support.

The catalyst can comprise iron oxide on a metal oxide support. The catalyst can consist essentially of iron oxide on a metal oxide support. The catalyst can consist of iron oxide on a metal oxide support. The catalyst can comprise iron oxide on an alumina support. The catalyst can comprise iron oxide on a magnesium oxide support. The catalyst can comprise iron oxide on a titanium oxide support. The catalyst can comprise iron oxide on a zinc oxide support. The catalyst can comprise iron oxide on a zirconia support. The catalyst can comprise iron oxide on a chromia support. The catalyst can consist essentially of iron oxide on an alumina support. The catalyst can consist essentially of iron oxide on a magnesium oxide support. The catalyst can consist essentially of iron oxide on a titanium oxide support. The catalyst can consist essentially of iron oxide on a zinc oxide support. The catalyst can consist essentially of iron oxide on a zirconia support. The catalyst can consist essentially of iron oxide on a chromia support. The catalyst can consist of iron oxide on an alumina support. The catalyst can consist of iron oxide on a magnesium oxide support. The catalyst can consist of iron oxide on a titanium oxide support. The catalyst can consist of iron oxide on a zinc oxide support. The catalyst can consist of iron oxide on a zirconia support. The catalyst can consist of iron oxide on a chromia support.

The catalyst can comprise iron and iron oxide on a silica gel support. The catalyst can comprise iron and iron oxide on a silica-alumina support. The catalyst can comprise iron and iron oxide on a zeolite support. The catalyst can comprise iron and iron oxide on an activated carbon support. The catalyst can comprise iron and iron oxide on a silicon carbide support. The catalyst can consist essentially of iron and iron oxide on a silica gel support. The catalyst can consist essentially of iron and iron oxide on a silica-alumina support. The catalyst can consist essentially of iron and iron oxide on a zeolite support. The catalyst can consist essentially of iron and iron oxide on an activated carbon support. The catalyst can consist essentially of iron and iron oxide on a silicon carbide support. The catalyst can consist of iron and iron oxide on a silica gel support. The catalyst can consist of iron and iron oxide on a silica-alumina support. The catalyst can consist of iron and iron oxide on a zeolite support. The catalyst can consist of iron and iron oxide on an activated carbon support. The catalyst can consist of iron and iron oxide on a silicon carbide support.

The catalyst can comprise iron and iron oxide on a metal oxide support. The catalyst can consist essentially of iron and iron oxide on a metal oxide support. The catalyst can consist of iron and iron oxide on a metal oxide support. The catalyst can comprise iron and iron oxide on an alumina support. The catalyst can comprise iron and iron oxide on a magnesium oxide support. The catalyst can comprise iron and iron oxide on a titanium oxide support. The catalyst can comprise iron and iron oxide on a zinc oxide support. The catalyst can comprise iron and iron oxide on a zirconia support. The catalyst can comprise iron and iron oxide on a chromia support. The catalyst can consist essentially of iron and iron oxide on an alumina support. The catalyst can consist essentially of iron and iron oxide on a magnesium oxide support. The catalyst can consist essentially of iron and iron oxide on a titanium oxide support. The catalyst can consist essentially of iron and iron oxide on a zinc oxide support. The catalyst can consist essentially of iron and iron oxide on a zirconia support. The catalyst can consist essentially of iron and iron oxide on a chromia support. The catalyst can consist of iron and iron oxide on an alumina support. The catalyst can consist of iron and iron oxide on a magnesium oxide support. The catalyst can consist of iron and iron oxide on a titanium oxide support. The catalyst can consist of iron and iron oxide on a zinc oxide support. The catalyst can consist of iron and iron oxide on a zirconia support. The catalyst can consist of iron and iron oxide on a chromia support.

The catalyst can comprise nickel and cobalt on a silica gel support. The catalyst can comprise nickel and cobalt on a silica-alumina support. The catalyst can comprise nickel and cobalt on a zeolite support. The catalyst can comprise nickel and cobalt on an activated carbon support. The catalyst can comprise nickel and cobalt on a silicon carbide support. The catalyst can consist essentially of nickel and cobalt on a silica gel support. The catalyst can consist essentially of nickel and cobalt on a silica-alumina support. The catalyst can consist essentially of nickel and cobalt on a zeolite support. The catalyst can consist essentially of nickel and cobalt on an activated carbon support. The catalyst can consist essentially of nickel and cobalt on a silicon carbide support. The catalyst can consist of nickel and cobalt on a silica gel support. The catalyst can consist of nickel and cobalt on a silica-alumina support. The catalyst can consist of nickel and cobalt on a zeolite support. The catalyst can consist of nickel and cobalt on an activated carbon support. The catalyst can consist of nickel and cobalt on a silicon carbide support.

The catalyst can comprise nickel and cobalt on a metal oxide support. The catalyst can consist essentially of nickel and cobalt on a metal oxide support. The catalyst can consist of nickel and cobalt on a metal oxide support. The catalyst can comprise nickel and cobalt on an alumina support. The catalyst can comprise nickel and cobalt on a magnesium oxide support. The catalyst can comprise nickel and cobalt on a titanium oxide support. The catalyst can comprise nickel and cobalt on a zinc oxide support. The catalyst can comprise nickel and cobalt on a zirconia support. The catalyst can comprise nickel and cobalt on a chromia support. The catalyst can consist essentially of nickel and cobalt on an alumina support. The catalyst can consist essentially of nickel and cobalt on a magnesium oxide support. The catalyst can consist essentially of nickel and cobalt on a titanium oxide support. The catalyst can consist essentially of nickel and cobalt on a zinc oxide support. The catalyst can consist essentially of nickel and cobalt on a zirconia support. The catalyst can consist essentially of nickel and cobalt on a chromia support. The catalyst can consist of nickel and cobalt on an alumina support. The catalyst can consist of nickel and cobalt on a magnesium oxide support. The catalyst can consist of nickel and cobalt on a titanium oxide support. The catalyst can consist of nickel and cobalt on a zinc oxide support. The catalyst can consist of nickel and cobalt on a zirconia support. The catalyst can consist of nickel and cobalt on a chromia support.

The catalyst can comprise nickel oxide and cobalt oxide on a silica gel support. The catalyst can comprise nickel oxide and cobalt oxide on a silica-alumina support. The catalyst can comprise nickel oxide and cobalt oxide on a zeolite support. The catalyst can comprise nickel oxide and cobalt oxide on an activated carbon support. The catalyst can comprise nickel oxide and cobalt oxide on a silicon carbide support. The catalyst can consist essentially of nickel oxide and cobalt oxide on a silica gel support. The catalyst can consist essentially of nickel oxide and cobalt oxide on a silica-alumina support. The catalyst can consist essentially of nickel oxide and cobalt oxide on a zeolite support. The catalyst can consist essentially of nickel oxide and cobalt oxide on an activated carbon support. The catalyst can consist essentially of nickel oxide and cobalt oxide on a silicon carbide support. The catalyst can consist of nickel oxide and cobalt oxide on a silica gel support. The catalyst can consist of nickel oxide and cobalt oxide on a silica-alumina support. The catalyst can consist of nickel oxide and cobalt oxide on a zeolite support. The catalyst can consist of nickel oxide and cobalt oxide on an activated carbon support. The catalyst can consist of nickel oxide and cobalt oxide on a silicon carbide support.

The catalyst can comprise nickel oxide and cobalt oxide on a metal oxide support. The catalyst can consist essentially of nickel oxide and cobalt oxide on a metal oxide support. The catalyst can consist of nickel oxide and cobalt oxide on a metal oxide support. The catalyst can comprise nickel oxide and cobalt oxide on an alumina support. The catalyst can comprise nickel oxide and cobalt oxide on a magnesium oxide support. The catalyst can comprise nickel oxide and cobalt oxide on a titanium oxide support. The catalyst can comprise nickel oxide and cobalt oxide on a zinc oxide support. The catalyst can comprise nickel oxide and cobalt oxide on a zirconia support. The catalyst can comprise nickel oxide and cobalt oxide on a chromia support. The catalyst can consist essentially of nickel oxide and cobalt oxide on an alumina support. The catalyst can consist essentially of nickel oxide and cobalt oxide on a magnesium oxide support. The catalyst can consist essentially of nickel oxide and cobalt oxide on a titanium oxide support. The catalyst can consist essentially of nickel oxide and cobalt oxide on a zinc oxide support. The catalyst can consist essentially of nickel oxide and cobalt oxide on a zirconia support. The catalyst can consist essentially of nickel oxide and cobalt oxide on a chromia support. The catalyst can consist of nickel oxide and cobalt oxide on an alumina support. The catalyst can consist of nickel oxide and cobalt oxide on a magnesium oxide support. The catalyst can consist of nickel oxide and cobalt oxide on a titanium oxide support. The catalyst can consist of nickel oxide and cobalt oxide on a zinc oxide support. The catalyst can consist of nickel oxide and cobalt oxide on a zirconia support. The catalyst can consist of nickel oxide and cobalt oxide on a chromia support.

The catalyst can comprise nickel and iron on a silica gel support. The catalyst can comprise nickel and iron on a silica-alumina support. The catalyst can comprise nickel and iron on a zeolite support. The catalyst can comprise nickel and iron on an activated carbon support. The catalyst can comprise nickel and iron on a silicon carbide support. The catalyst can consist essentially of nickel and iron on a silica gel support. The catalyst can consist essentially of nickel and iron on a silica-alumina support. The catalyst can consist essentially of nickel and iron on a zeolite support. The catalyst can consist essentially of nickel and iron on an activated carbon support. The catalyst can consist essentially of nickel and iron on a silicon carbide support. The catalyst can consist of nickel and iron on a silica gel support. The catalyst can consist of nickel and iron on a silica-alumina support. The catalyst can consist of nickel and iron on a zeolite support. The catalyst can consist of nickel and iron on an activated carbon support. The catalyst can consist of nickel and iron on a silicon carbide support.

The catalyst can comprise nickel and iron on a metal oxide support. The catalyst can consist essentially of nickel and iron on a metal oxide support. The catalyst can consist of nickel and iron on a metal oxide support. The catalyst can comprise nickel and iron on an alumina support. The catalyst can comprise nickel and iron on a magnesium oxide support. The catalyst can comprise nickel and iron on a titanium oxide support. The catalyst can comprise nickel and iron on a zinc oxide support. The catalyst can comprise nickel and iron on a zirconia support. The catalyst can comprise nickel and iron on a chromia support. The catalyst can consist essentially of nickel and iron on an alumina support. The catalyst can consist essentially of nickel and iron on a magnesium oxide support. The catalyst can consist essentially of nickel and iron on a titanium oxide support. The catalyst can consist essentially of nickel and iron on a zinc oxide support. The catalyst can consist essentially of nickel and iron on a zirconia support. The catalyst can consist essentially of nickel and iron on a chromia support. The catalyst can consist of nickel and iron on an alumina support. The catalyst can consist of nickel and iron on a magnesium oxide support. The catalyst can consist of nickel and iron on a titanium oxide support. The catalyst can consist of nickel and iron on a zinc oxide support. The catalyst can consist of nickel and iron on a zirconia support. The catalyst can consist of nickel and iron on a chromia support.

The catalyst can comprise nickel and molybdenum on a silica gel support. The catalyst can comprise nickel and molybdenum on a silica-alumina support. The catalyst can comprise nickel and molybdenum on a zeolite support. The catalyst can comprise nickel and molybdenum on an activated carbon support. The catalyst can comprise nickel and molybdenum on a silicon carbide support. The catalyst can consist essentially of nickel and molybdenum on a silica gel support. The catalyst can consist essentially of nickel and molybdenum on a silica-alumina support. The catalyst can consist essentially of nickel and molybdenum on a zeolite support. The catalyst can consist essentially of nickel and molybdenum on an activated carbon support. The catalyst can consist essentially of nickel and molybdenum on a silicon carbide support. The catalyst can consist of nickel and molybdenum on a silica gel support. The catalyst can consist of nickel and molybdenum on a silica-alumina support. The catalyst can consist of nickel and molybdenum on a zeolite support. The catalyst can consist of nickel and molybdenum on an activated carbon support. The catalyst can consist of nickel and molybdenum on a silicon carbide support.

The catalyst can comprise nickel and molybdenum on a metal oxide support. The catalyst can consist essentially of nickel and molybdenum on a metal oxide support. The catalyst can consist of nickel and molybdenum on a metal oxide support. The catalyst can comprise nickel and molybdenum on an alumina support. The catalyst can comprise nickel and molybdenum on a magnesium oxide support. The catalyst can comprise nickel and molybdenum on a zinc oxide support. The catalyst can comprise nickel and molybdenum on a zirconia support. The catalyst can comprise nickel and molybdenum on a chromia support. The catalyst can consist essentially of nickel and molybdenum on an alumina support. The catalyst can consist essentially of nickel and molybdenum on a magnesium oxide support. The catalyst can consist essentially of nickel and molybdenum on a zinc oxide support. The catalyst can consist essentially of nickel and molybdenum on a zirconia support. The catalyst can consist essentially of nickel and molybdenum on a chromia support. The catalyst can consist of nickel and molybdenum on an alumina support. The catalyst can consist of nickel and molybdenum on a magnesium oxide support. The catalyst can consist of nickel and molybdenum on a zinc oxide support. The catalyst can consist of nickel and molybdenum on a zirconia support. The catalyst can consist of nickel and molybdenum on a chromia support.

The catalyst can comprise nickel and tungsten on a silica gel support. The catalyst can comprise nickel and tungsten on a silica-alumina support. The catalyst can comprise nickel and tungsten on a zeolite support. The catalyst can comprise nickel and tungsten on an activated carbon support. The catalyst can comprise nickel and tungsten on a silicon carbide support. The catalyst can consist essentially of nickel and tungsten on a silica gel support. The catalyst can consist essentially of nickel and tungsten on a silica-alumina support. The catalyst can consist essentially of nickel and tungsten on a zeolite support. The catalyst can consist essentially of nickel and tungsten on an activated carbon support. The catalyst can consist essentially of nickel and tungsten on a silicon carbide support. The catalyst can consist of nickel and tungsten on a silica gel support. The catalyst can consist of nickel and tungsten on a silica-alumina support. The catalyst can consist of nickel and tungsten on a zeolite support. The catalyst can consist of nickel and tungsten on an activated carbon support. The catalyst can consist of nickel and tungsten on a silicon carbide support.

The catalyst can comprise nickel and tungsten on a metal oxide support. The catalyst can consist essentially of nickel and tungsten on a metal oxide support. The catalyst can consist of nickel and tungsten on a metal oxide support. The catalyst can comprise nickel and tungsten on an alumina support. The catalyst can comprise nickel and tungsten on a magnesium oxide support. The catalyst can comprise nickel and tungsten on a zinc oxide support. The catalyst can comprise nickel and tungsten on a zirconia support. The catalyst can comprise nickel and tungsten on a chromia support. The catalyst can consist essentially of nickel and tungsten on an alumina support. The catalyst can consist essentially of nickel and tungsten on a magnesium oxide support. The catalyst can consist essentially of nickel and tungsten on a zinc oxide support. The catalyst can consist essentially of nickel and tungsten on a zirconia support. The catalyst can consist essentially of nickel and tungsten on a chromia support. The catalyst can consist of nickel and tungsten on an alumina support. The catalyst can consist of nickel and tungsten on a magnesium oxide support. The catalyst can consist of nickel and tungsten on a zinc oxide support. The catalyst can consist of nickel and tungsten on a zirconia support. The catalyst can consist of nickel and tungsten on a chromia support.

The catalyst can comprise nickel oxide and iron oxide on a silica gel support. The catalyst can comprise nickel oxide and iron oxide on a silica-alumina support. The catalyst can comprise nickel oxide and iron oxide on a zeolite support. The catalyst can comprise nickel oxide and iron oxide on an activated carbon support. The catalyst can comprise nickel oxide and iron oxide on a silicon carbide support. The catalyst can consist essentially of nickel oxide and iron oxide on a silica gel support. The catalyst can consist essentially of nickel oxide and iron oxide on a silica-alumina support. The catalyst can consist essentially of nickel oxide and iron oxide on a zeolite support. The catalyst can consist essentially of nickel oxide and iron oxide on an activated carbon support. The catalyst can consist essentially of nickel oxide and iron oxide on a silicon carbide support. The catalyst can consist of nickel oxide and iron oxide on a silica gel support. The catalyst can consist of nickel oxide and iron oxide on a silica-alumina support. The catalyst can consist of nickel oxide and iron oxide on a zeolite support. The catalyst can consist of nickel oxide and iron oxide on an activated carbon support. The catalyst can consist of nickel oxide and iron oxide on a silicon carbide support.

The catalyst can comprise nickel oxide and iron oxide on a metal oxide support. The catalyst can consist essentially of nickel oxide and iron oxide on a metal oxide support. The catalyst can consist of nickel oxide and iron oxide on a metal oxide support. The catalyst can comprise nickel oxide and iron oxide on an alumina support. The catalyst can comprise nickel oxide and iron oxide on a magnesium oxide support. The catalyst can comprise nickel oxide and iron oxide on a titanium oxide support. The catalyst can comprise nickel oxide and iron oxide on a zinc oxide support. The catalyst can comprise nickel oxide and iron oxide on a zirconia support. The catalyst can comprise nickel oxide and iron oxide on a chromia support. The catalyst can consist essentially of nickel oxide and iron oxide on an alumina support. The catalyst can consist essentially of nickel oxide and iron oxide on a magnesium oxide support. The catalyst can consist essentially of nickel oxide and iron oxide on a titanium oxide support. The catalyst can consist essentially of nickel oxide and iron oxide on a zinc oxide support. The catalyst can consist essentially of nickel oxide and iron oxide on a zirconia support. The catalyst can consist essentially of nickel oxide and iron oxide on a chromia support. The catalyst can consist of nickel oxide and iron oxide on an alumina support. The catalyst can consist of nickel oxide and iron oxide on a magnesium oxide support. The catalyst can consist of nickel oxide and iron oxide on a titanium oxide support. The catalyst can consist of nickel oxide and iron oxide on a zinc oxide support. The catalyst can consist of nickel oxide and iron oxide on a zirconia support. The catalyst can consist of nickel oxide and iron oxide on a chromia support.

The catalyst can comprise cobalt and iron on a silica gel support. The catalyst can comprise cobalt and iron on a silica-alumina support. The catalyst can comprise cobalt and iron on a zeolite support. The catalyst can comprise cobalt and iron on an activated carbon support. The catalyst can comprise cobalt and iron on a silicon carbide support. The catalyst can consist essentially of cobalt and iron on a silica gel support. The catalyst can consist essentially of cobalt and iron on a silica-alumina support. The catalyst can consist essentially of cobalt and iron on a zeolite support. The catalyst can consist essentially of cobalt and iron on an activated carbon support. The catalyst can consist essentially of cobalt and iron on a silicon carbide support. The catalyst can consist of cobalt and iron on a silica gel support. The catalyst can consist of cobalt and iron on a silica-alumina support. The catalyst can consist of cobalt and iron on a zeolite support. The catalyst can consist of cobalt and iron on an activated carbon support. The catalyst can consist of cobalt and iron on a silicon carbide support.

The catalyst can comprise cobalt and iron on a metal oxide support. The catalyst can consist essentially of cobalt and iron on a metal oxide support. The catalyst can consist of cobalt and iron on a metal oxide support. The catalyst can comprise cobalt and iron on an alumina support. The catalyst can comprise cobalt and iron on a magnesium oxide support. The catalyst can comprise cobalt and iron on a titanium oxide support. The catalyst can comprise cobalt and iron on a zinc oxide support. The catalyst can comprise cobalt and iron on a zirconia support. The catalyst can comprise cobalt and iron on a chromia support. The catalyst can consist essentially of cobalt and iron on an alumina support. The catalyst can consist essentially of cobalt and iron on a magnesium oxide support. The catalyst can consist essentially of cobalt and iron on a titanium oxide support. The catalyst can consist essentially of cobalt and iron on a zinc oxide support. The catalyst can consist essentially of cobalt and iron on a zirconia support. The catalyst can consist essentially of cobalt and iron on a chromia support. The catalyst can consist of cobalt and iron on an alumina support. The catalyst can consist of cobalt and iron on a magnesium oxide support. The catalyst can consist of cobalt and iron on a titanium oxide support. The catalyst can consist of cobalt and iron on a zinc oxide support. The catalyst can consist of cobalt and iron on a zirconia support. The catalyst can consist of cobalt and iron on a chromia support.

The catalyst can comprise cobalt oxide and iron oxide on a silica gel support. The catalyst can comprise cobalt oxide and iron oxide on a silica-alumina support. The catalyst can comprise cobalt oxide and iron oxide on a zeolite support. The catalyst can comprise cobalt oxide and iron oxide on an activated carbon support. The catalyst can comprise cobalt oxide and iron oxide on a silicon carbide support. The catalyst can consist essentially of cobalt oxide and iron oxide on a silica gel support. The catalyst can consist essentially of cobalt oxide and iron oxide on a silica-alumina support. The catalyst can consist essentially of cobalt oxide and iron oxide on a zeolite support. The catalyst can consist essentially of cobalt oxide and iron oxide on an activated carbon support. The catalyst can consist essentially of cobalt oxide and iron oxide on a silicon carbide support. The catalyst can consist of cobalt oxide and iron oxide on a silica gel support. The catalyst can consist of cobalt oxide and iron oxide on a silica-alumina support. The catalyst can consist of cobalt oxide and iron oxide on a zeolite support. The catalyst can consist of cobalt oxide and iron oxide on an activated carbon support. The catalyst can consist of cobalt oxide and iron oxide on a silicon carbide support.

The catalyst can comprise cobalt oxide and iron oxide on a metal oxide support. The catalyst can consist essentially of cobalt oxide and iron oxide on a metal oxide support. The catalyst can consist of cobalt oxide and iron oxide on a metal oxide support. The catalyst can comprise cobalt oxide and iron oxide on an alumina support. The catalyst can comprise cobalt oxide and iron oxide on a magnesium oxide support. The catalyst can comprise cobalt oxide and iron oxide on a titanium oxide support. The catalyst can comprise cobalt oxide and iron oxide on a zinc oxide support. The catalyst can comprise cobalt oxide and iron oxide on a zirconia support. The catalyst can comprise cobalt oxide and iron oxide on a chromia support. The catalyst can consist essentially of cobalt oxide and iron oxide on an alumina support. The catalyst can consist essentially of cobalt oxide and iron oxide on a magnesium oxide support. The catalyst can consist essentially of cobalt oxide and iron oxide on a titanium oxide support. The catalyst can consist essentially of cobalt oxide and iron oxide on a zinc oxide support. The catalyst can consist essentially of cobalt oxide and iron oxide on a zirconia support. The catalyst can consist essentially of cobalt oxide and iron oxide on a chromia support. The catalyst can consist of cobalt oxide and iron oxide on an alumina support. The catalyst can consist of cobalt oxide and iron oxide on a magnesium oxide support. The catalyst can consist of cobalt oxide and iron oxide on a titanium oxide support. The catalyst can consist of cobalt oxide and iron oxide on a zinc oxide support. The catalyst can consist of cobalt oxide and iron oxide on a zirconia support. The catalyst can consist of cobalt oxide and iron oxide on a chromia support.

Table 1 below provides a summary of potential catalysts, supports, and optional promoters that may be used. The catalyst may comprise any catalyst(s) from column A1 and/or column A2 on any support(s) listed in column B. The catalyst may also be combined with at least one optional promoter selected from column C. For example, the catalyst may comprise nickel on an alumina support. The catalyst may comprise nickel iodide on an alumina support. The catalyst may comprise cobalt on a silica support. While they may not be explicitly listed, the catalyst may comprise any combination of catalyst(s), support(s), and optional promoter(s) shown in Table 1.

TABLE 1
Catalyst for conversion of H₂ and I₂ to HI

| Column A1: | Column A2: | Column B: | Column C: |
|---|---|---|---|
| Catalyst | Catalyst | Support | Promoter |
| Ni | CuF₂ | Alumina | Zn |
| NiI₂ | CuCl | Carbon | ZnO |
| NiF₂ | CuCl₂ | Silica gel | ZnI₂ |
| NiCl₂ | CuBr | Silica-aluminas | ZnF₂ |
| NiBr₂ | CuBr₂ | TiO₂ | ZnCl₂ |
| Co | Fel₂ | ZrO₂ | ZnBr₂ |
| CoI₂ | FeCl₂ | 3A Zeolite | Mn |
| CoF₂ | FeCl₃ | 4A Zeolite | MnO |
| CoCl₂ | Cu | 5A Zeolite | MnI₂ |
| CoBr₂ | CuO | XH-9 Zeolite | MnF₂ |
| CuI | Cu₂O | 13X Zeolite | MnCl₂ |
| Mo | W | Silicon Carbide | MnBr₂ |
| — | — | — | KI |
| — | — | — | KF |
| — | — | — | KCl |

The catalyst may be in the form of beads, pellets, extrudates, powder, spheres, or mesh. Preferably, the catalyst comprises nickel or nickel iodide on an alumina support. More preferably, the catalyst comprises nickel or nickel iodide on an alumina support in the form of pellets. Most preferably, the catalyst comprises nickel or nickel iodide on an alumina support in the form of pellets having a diameter ranging from about 1 mm to about 7 mm.

The catalyst may be commercially available. Various loadings (weight percentages) of nickel metal supported on alumina can be obtained from Honeywell UOP, Des Plaines, IL, USA or Johnson Matthey, London, UK, for example.

The weight percentage of the catalyst, as a percentage of the total weight of the catalyst and the support, may be as little as about 0.01 weight percent (wt. %), about 0.1 wt. % about 1 wt. %, about 3 wt. %, about 5 wt. %, about 10 wt. %, about 15%, or about 20 wt. %, or as high as about 35 wt. %, about 40 wt. %, about 45 wt. %, about 50 wt. %, about 75 wt. % or within any range defined between any two of the foregoing values, such as about 0.01 wt. % to about 75 wt. %, about 0.1 wt. % to about 50 wt. %, about 3 wt. % to about 45 wt. %, about 10 wt. % to about 40 wt. %, about 15 wt. % to about 35 wt. %, or about 3 wt. % to about 25 wt. %, for example. Preferably, weight percentage of the catalyst is from about 5 wt. % to about 45 wt. %. More preferably, the weight percentage of the catalyst is from about 10 wt. % to about 40 wt. %. Most preferably, the weight percentage of the catalyst is from about 15 wt. % to about 35 wt. %.

The catalyst may have a surface area as small as about 1 square meters per gram (m²/g), about 5 m²/g, about 10 m²/g, about 25 m²/g, about 40 m²/g, about 60 m²/g, or about 80 m²/g, or as large as about 100 m²/g, about 120 m²/g, about 150 m²/g, about 200 m²/g, about 250 m²/g, about 300 m²/g, or about 1,000 m²/g, or within any range defined between any two of the foregoing values, such as about 1 m²/g to about 1.00 m²/g, about 5 m²/g to about 300 m²/g, about 10 m²/g to about 250 m²/g, about 25 m²/g to about 200 m²/g, about 40 m²/g to about 150 m²/g, about 60 m²/g to about 120 m²/g, or about 80 m²/g to about 120 m²/g, for example. The surface area of the catalyst is determined by the BET method per ISO 9277:2010.

The reactant stream may be in contact with the catalyst for a contact time as short as about 0.1 second, about 2 seconds, about 4 seconds, about 6 seconds, about 8 seconds, about 10 seconds, about 15 seconds, about 20 seconds, about 25 seconds, or about 30 seconds, or as long as about 40 seconds, about 50 seconds, about 60 seconds, about 70 seconds, about 80 seconds, about 100 seconds, about 120 seconds, about 200 seconds, or about 1,800 seconds or within any range defined between any two of the foregoing values, such as about 0.1 seconds to about 1,800 seconds, about 2 seconds to about 120 seconds, about 4 second to about 100 seconds, about 6 seconds to about 80 seconds, about 8 seconds to about 70 seconds, about 10 seconds to about 60 seconds, about 15 seconds to about 50 seconds, about 20 seconds to about 40 seconds, about 20 seconds to about 30 seconds, about 10 seconds to about 20 seconds, or about 100 seconds to about 120 seconds, for example. Preferably, the reactant stream is in contact with the catalyst for a contact time from about 2 seconds to about 200 seconds. More preferably, the reactant stream is in contact with the catalyst for a contact time from about 40 seconds to about 100 seconds. Most preferably, the reactant stream is in contact with the catalyst for a contact time from about 60 seconds to about 80 seconds.

The reactant stream and the catalyst may be pre-heated to a reaction temperature. The reaction temperature may be as low as about 150° C., about 200° C., about 250° C., about 280° C., about 290° C., about 300° C., about 310° C., or about 320° C., or to a reaction temperature as high as about 330° C., about 340° C., about 350° C., about 360° C., about 380° C., about 400° C., about 450° C., about 500° C., about 550° C., or about 600° C., or within any range defined between any two of the foregoing values, such as about 150° C. to about 600° C., about 200° C. to about 550° C., about 250° C. to about 500° C., about 280° C. to about 450° C., about 290° C. to about 400° C., about 300° C. to about 380° C., about 310° C. to about 360° C., about 320° C. to about 350° C., or about 320° C. to about 340° C., for example. Preferably, the reaction temperature is from about 200° C. to about 500° C. More preferably, the reaction temperature is from about 300° C. to about 400° C. Most preferably, the reaction temperature is from about 300° C. to about 350° C.

The hydrogen in the flow of reactants to the reactor will reduce a catalyst including nickel oxide, cobalt oxide, and/or iron oxide to the corresponding metal. Preferably, such catalysts are reduced by a flow of hydrogen through the reactor prior to the reaction to reduce the catalyst to the corresponding metal.

An operating pressure of the reactor may be as low as about 10 kPag (kilo Pascals, gauge pressure), about 50 kPag, about 100 kPag, about 200 kPag, about 300 kPag, about 400 kPag or about 600 kPag, or as high as about 800 kPag, about 1,000 kPag, about 1,500 kPag, about 2,000 kPag, about 2,500 kPag, about 3,000 kPag, or about 4,000 kPag, or within any range defined between any two of the foregoing values, such as about 10 kPag to about 4,000 kPag, about 50 kPag to about 3,000 kPag, about 100 kPag to about 2,500 kPag, about 200 kPag to about 2,000 kPag, about 300 kPag to about 1,500 kPag, about 400 kPag to about 1,000 kPag, about 600 kPag to about 800 kPag, or about 10 kPag to about 800 kPag, for example. Preferably, the operating pressure of the reactor is from about 10 kPag, to about 1500 kPag. More preferably, the operating pressure of the reactor is from about 10 kPag to about 1000 kPag. Most preferably, the operating pressure of the reactor is from about 10 kPag to about 800 kPag.

The iodine is provided to the reactor from solid iodine continuously or intermittently added to a heated iodine liquefier to maintain certain level of liquid iodine in the liquefier. A positive pressure is maintained in the liquefier to deliver liquid iodine to an iodine vaporizer. A flow rate of the liquid iodine may be provided by monitoring the weight loss of a vessel providing the iodine, by calculating based on a pump stroke volume if a pump is used, and/or by passing the liquid iodine through a flowmeter, for example. The temperature of the iodine in the iodine liquefier is maintained such that the temperature is high enough to melt iodine, but low enough to avoid vaporizing the iodine. The liquid iodine is vaporized in the vaporizer to form an iodine vapor. The iodine vapor leaving the vaporizer can be mixed with the hydrogen gas from a hydrogen supply to form the reactant stream. Alternatively, or additionally, the hydrogen gas from the hydrogen supply may be provided to the iodine vaporizer to assist in the vaporization of the iodine, thus reducing the vaporization temperature. In either case, the hydrogen gas may further include recycled hydrogen gas and hydrogen iodide. The reactant stream is preheated to the reaction temperature and fed to a reactor that is preloaded with any of the catalysts described above. Process lines between the liquefier and the vaporizer are insulated and optionally heat-traced to ensure that iodine remains liquid in these lines. Process lines carrying the iodine vapor and the hydrogen/iodine vapor mixture are insulated and optionally heat-traced to ensure that the gas phase is maintained. Alternatively, the solid iodine may be provided to a vessel that both liquefies and vaporizes the iodine to produce the iodine vapor in the presence or absence of hydrogen and hydrogen iodide.

The product stream including hydrogen iodide, unreacted hydrogen, and unreacted iodine is directed from the reactor to one or more iodine removal vessels in which the product stream is cooled to allow the unreacted iodine to condense to remove at least some of the iodine from the product stream to be recycled as a reactant. Optionally, the product stream is directed to a cooler to remove some of the heat from the product stream before condensing the unreacted iodine in the one or more iodine removal vessels. In the one or more iodine removal vessels, the product stream may be cooled to a temperature lower than the boiling point of iodine, but above the melting point of iodine, to recover the iodine in liquid form. Alternatively, or additionally, the product stream leaving the reactor may be cooled to a temperature lower than the melting point of iodine to recover the iodine in solid form. The product stream may proceed from the one or more iodine removal vessels to one or more additional iodine removal vessels to remove additional unreacted iodine for recycle.

The product stream, which may be substantially free of iodine, can be directed from the one or more iodine removal vessels to a compressor to increase the pressure of the product stream to a separation pressure sufficient for efficient recovery of unreacted hydrogen. The separation pressure is greater than the operating pressure of the reactor. The separation pressure can be as low as about 800 kPag, about 850 kPag, about 900 kPag, about 950 kPag or about 1,000 kPag, or as high as about 1,100 kPag, about 1,200 kPag, about 1,300 kPag, about 1,400 kPag or about 1,500 kPag, or within any range defined between any two of the foregoing values, such as about 800 kPag to about 1,500 kPag, about 850 kPag to about 1,400 kPag, about 900 kPag to about 1,300 kPag, about 950 kPag to about 1,200 kPag, about 1,000 kPag to about 1,100 kPag, or about 900 kPag to about 1,100 kPag, for example. Preferably, the separation pressure is from about 10 kPag to about 2,000 kPag. More preferably, the separation pressure is from about 300 kPag to about 1,500 kPag. Most preferably, the separation pressure is from about 600 kPag to about 1,000 kPag.

The compressed product stream is subjected to a one-stage flash cooling or a distillation to recover a liquid stream and a vapor stream. The vapor stream includes hydrogen and small amounts of hydrogen iodide. The liquid stream is substantially free of hydrogen and includes the hydrogen iodide, residual iodine and other higher boiling point substances, such as any water. The vapor stream can be recycled to the reactor. The liquid stream is directed to a distillation column to separate liquid hydrogen iodide in the overhead stream from residual iodine and other higher boiling point substances including any residual water in the bottom stream. The higher boiling point substances are directed from the bottom stream of the distillation column for further processing including iodine recovery and recycle. A vapor vent from the overhead of the distillation column may be taken as a purge to remove any non-condensable gases, such as hydrogen.

Alternatively, the product stream can be directed from the one or more iodine removal vessels to a heavies distillation column to separate higher boiling point substances, such as hydrogen iodide and any residual iodine, from lower boiling point substances, such as unreacted hydrogen. The higher boiling point substances are directed from a bottom stream of the heavies distillation column to an iodine recycle distillation column to separate the hydrogen iodide from the residual iodine. An overhead stream of the heavies column including the hydrogen and any residual hydrogen iodide is directed to a product distillation column. A bottom stream of the iodine recycle distillation column including the residual iodine is recycled back to the iodine liquefier. An overhead stream of the iodine recycle column including the hydrogen iodide is directed to the product distillation column to separate the hydrogen iodide from the hydrogen and other non-condensable gases from the heavies column and the iodine recycle column. An overhead stream of the product column, including hydrogen and residual hydrogen iodide, may be recycled back to the reactor. A bottom stream of the product column includes the purified hydrogen iodide.

In either of the processes described above, additional product columns may be added to increase the purity of the hydrogen iodide. The purified hydrogen iodide may be passed through an appropriate desiccant to remove any residual moisture before use in subsequent processes, such as any of the processes discussed above, for example. The purified hydrogen iodide may be provided directly to the subsequent processes.

Alternatively, or additionally, the purified hydrogen iodide may be collected in the storage tank for short term storage before use in subsequent processes. The recycle of iodine and hydrogen results in an efficient process for producing hydrogen iodide.

The processes for the manufacture of hydrogen iodide (HI) from hydrogen (H₂) and elemental iodine (I₂) that include the use of a nickel, cobalt, iron, nickel oxide, cobalt oxide, and/or iron oxide catalyst supported on a support according to this disclosure may be batch processes or may be continuous processes, as described below.

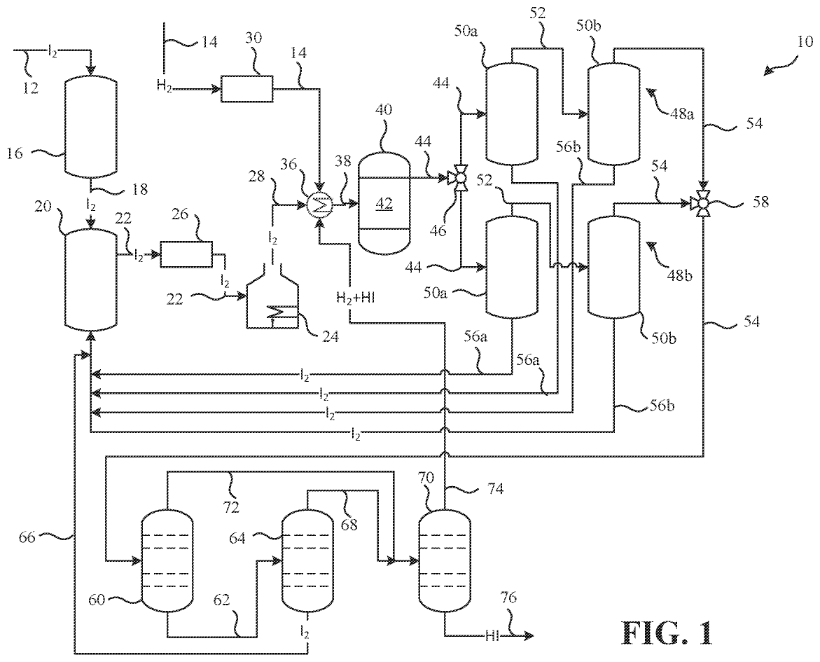

FIG. 1 is a process flow diagram showing an integrated process for manufacturing anhydrous hydrogen iodide. As shown in FIG. 1, an integrated process 10 includes material flows of solid iodine 12 and hydrogen gas 14. The solid iodine 12 may be continuously or intermittently added to a solid storage tank 16. A flow of solid iodine 18 is transferred, continuously or intermittently, by a solid conveying system (not shown) or by gravity from the solid storage tank 16 to an iodine liquefier 20 where the solid iodine is heated to above its melting point but below its boiling point to maintain a level of liquid iodine in the iodine liquefier 20. Although only one liquefier 20 is shown, it is understood that multiple liquefiers 20 may be used in a parallel arrangement. Liquid iodine 22 flows from the iodine liquefier 20 to an iodine vaporizer 24. The iodine liquefier 20 may be pressurized by an inert gas to drive the flow of liquid iodine 22. The inert gas may include nitrogen, argon, or helium, or mixtures thereof, for example. Alternatively, or additionally, the flow of liquid iodine 22 may be driven by a pump (not shown). The flow rate of the liquid iodine 22 may be controlled by a liquid flow controller 26. In the iodine vaporizer 24, the iodine is heated to above its boiling point to form a flow of iodine vapor 28.

The flow rate of the hydrogen 14 may be controlled by a gas flow controller 30. The flow of iodine vapor 28 and the flow of hydrogen 14 are provided to a superheater 36 and heated to the reaction temperature to form a reactant stream 38. The reactant stream 38 is provided to a reactor 40.

The reactant stream 38 reacts in the presence of a catalyst 42 contained within the reactor 40 to produce a product stream 44. The catalyst 42 may be any of the catalysts described herein. The product stream 44 may include hydrogen iodide, unreacted iodine, unreacted hydrogen and trace amounts of water and other high boiling impurities.

The product stream 44 may be provided to an upstream valve 46. The upstream valve 46 may direct the product stream 44 to an iodine removal step. Alternatively, the product stream 44 may pass through a cooler (not shown) to remove some of the heat before being directed to the iodine removal step. In the iodine removal step, a first iodine removal train 48a may include a first iodine removal vessel 50a and a second iodine removal vessel 50b. The product stream 44 may be cooled in the first iodine removal vessel 50a to a temperature below the boiling point of the iodine to condense or desublimate at least some of the iodine, separating it from the product stream 44. The product stream 44 may be further cooled in the first iodine removal vessel 50a to a temperature below the melting point of the iodine to separate even more iodine from the product stream 44, depositing at least some of the iodine within the first iodine removal vessel 50a as a solid and producing a reduced iodine product stream 52. The reduced iodine product stream 52 may be provided to the second iodine removal vessel 50b and cooled to separate at least some more of the iodine from the reduced iodine product stream 52 to produce a further crude hydrogen iodide product stream 54.

Although the first iodine removal train 48a consists of two iodine removal vessels operating in a series configuration, it is understood that the first iodine removal train 48a may include two or more iodine removal vessels operating in a parallel configuration, more than two iodine removal vessels operating in a series configuration, or any combination thereof. It is also understood that the first iodine removal train 48a may consist of a single iodine removal vessel. It is further understood that any of the iodine removal vessels may include, or be in the form of, heat exchangers. It is also understood that consecutive vessels may be combined into a single vessel having multiple cooling stages.

The iodine collected in the first iodine removal vessel 50a may form a first iodine recycle stream 56a. Similarly, the iodine collected in the second iodine removal vessel 50b may form a second iodine recycle stream 56b. Each of the first iodine recycle stream 56a and the second iodine recycle stream 56b may be provided continuously or intermittently to the iodine liquefier 20, as shown, and/or to the iodine vaporizer 24.

In order to provide continuous operation while collecting the iodine in solid form, the upstream valve 46 may be configured to selectively direct the product stream 44 to a second iodine removal train 48b. The second iodine removal train 48b may be substantially similar to the first iodine removal train 48a, as described above. Once either the first iodine removal vessel 50a or the second iodine removal vessel 50b of the first iodine removal train 48a accumulates enough solid iodine that it is beneficial to remove the solid iodine, the upstream valve 46 may be selected to direct the product stream 44 from the first iodine removal train 48a to the second iodine removal train 48b. At about the same time, a downstream valve 58 configured to selectively direct the crude hydrogen iodide product stream 54 from either of the first iodine removal train 48a or the second iodine removal train 48b may be selected to direct the crude hydrogen iodide product stream 54 from the second iodine removal train 48b so that the process of removing the iodine from the product stream 44 to produce the crude hydrogen iodide product stream 54 may continue uninterrupted. Once the product stream 44 is no longer directed to the first iodine removal train 48a, the first iodine removal vessel 50a and the second iodine removal vessel 50b of the first iodine removal train 48a may be heated to above the melting point of the iodine, liquefying the solid iodine so that it may flow through the first iodine recycle stream 56a and the second iodine recycle stream 56b of the first iodine removal train 48a to the iodine liquefier 20.

As the process continues and either of the first iodine removal vessel 50a or the second iodine removal vessel 50b of the second iodine removal train 48b accumulates enough solid iodine that it is beneficial to remove the solid iodine, the upstream valve 46 may be selected to direct the product stream 44 from the second iodine removal train 48b back to the first iodine removal train 48a, and the downstream valve 58 may be selected to direct the crude hydrogen iodide product stream 54 from the first iodine removal train 48a so that the process of removing the iodine from the product stream 44 to produce the crude hydrogen iodide product stream 54 may continue uninterrupted. Once the product stream 44 is no longer directed to the second iodine removal train 48b, the first iodine removal vessel 50a and the second iodine removal vessel 50b of the second iodine removal train 48b may be heated to above the melting point of the iodine, liquefying the solid iodine so that it may flow through the first iodine recycle stream 56a and the second iodine recycle stream 56b of the second iodine removal train 48b to the iodine liquefier 20. By continuing to switch between the first iodine removal train 48a and the second iodine removal train 48b, the unreacted iodine in the product stream 44 may be efficiently and continuously removed and recycled.

As described above, the liquid iodine may flow through the first iodine recycle streams 56a and the second iodine recycle streams 56b of the first iodine removal train 48a and the second iodine removal train 48b to the iodine liquefier 20. Alternatively, the liquid iodine may flow through the first iodine recycle streams 56a and the second iodine recycle streams 56b of the first iodine removal train 48a and the second iodine removal train 48b to the iodine vaporizer 24, bypassing the iodine liquefier 20 and the liquid flow controller 26.

In the integrated process shown in FIG. 1, the crude hydrogen iodide product stream 54 is provided to a heavies distillation column 60. The heavies distillation column 60 may be configured for the separation of higher boiling point substances, such as hydrogen iodide and residual unreacted iodine, from lower boiling point substances, such as the unreacted hydrogen. A bottom stream 62 including the hydrogen iodide and residual unreacted iodine from the heavies distillation column 60 may be provided to an iodine recycle column 64. The iodine recycle column 64 may be configured for the separation of the residual unreacted iodine from the hydrogen iodide. A bottom stream 66 of the iodine recycle column 64 including the unreacted iodine may be recycled back to the iodine liquefier 20. Alternatively, the bottom stream 66 of the iodine recycle column 64 including the unreacted iodine may be recycled back to the iodine vaporizer 24. An overhead stream 68 of the iodine recycle column 64 including the hydrogen iodide may be provided to a product distillation column 70.

An overhead stream 72 including the hydrogen and residual hydrogen iodide from the heavies distillation column 60 may also be provided to the product distillation column 70. The product distillation column 70 may be configured to separate the unreacted hydrogen from the hydrogen iodide. An overhead stream 74 of the product column 70 including the unreacted hydrogen and residual hydrogen iodide may be recycled back to the reactor 40. The resulting purified hydrogen iodide product may be collected from a bottom stream 76 of the product column 70.

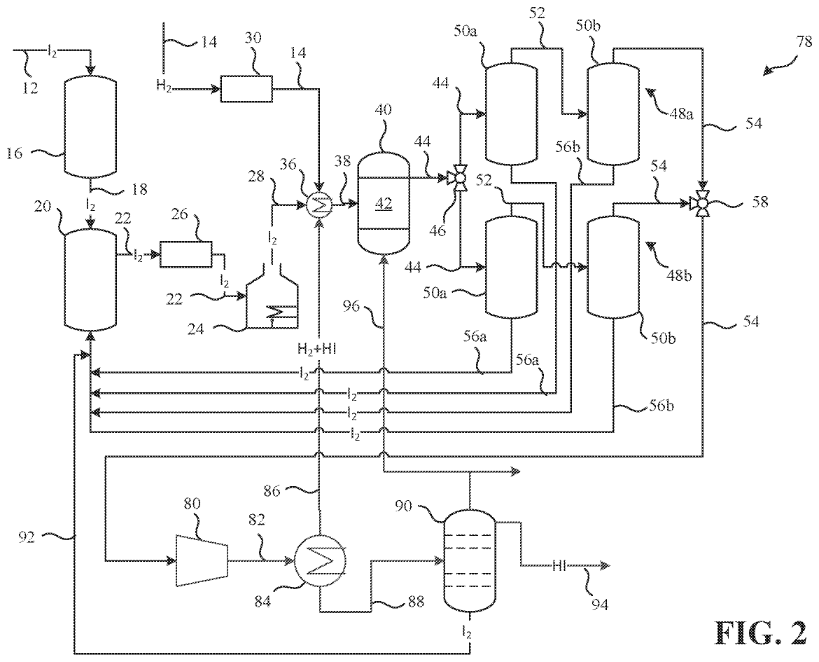

FIG. 2 is a process flow diagram showing another integrated process for manufacturing anhydrous hydrogen iodide. The integrated process 78 shown in FIG. 2 is the same as the integrated process 10 described above in reference to FIG. 1 up to the production of the crude hydrogen iodide product stream 54. In the integrated process 78 of FIG. 2, the crude hydrogen iodide product stream 54 is provided to a compressor 80 to increase the pressure of the crude hydrogen iodide product stream 54 to facilitate the recovery of the hydrogen and the hydrogen iodide. The compressor 80 increases the pressure of the crude hydrogen iodide product stream 54 to a separation pressure, that is greater than an operating pressure of the reactor 42 to produce a compressed product stream 82. The compressed product stream 82 is directed to a partial condenser 84 where it is subjected to a one-stage flash cooling for the separation of higher boiling point substances, such as hydrogen iodide and trace amounts of residual, unreacted iodine, from lower boiling point substances, such as the unreacted hydrogen. An overhead stream 86 including hydrogen and residual hydrogen iodide from the partial condenser 84 may be recycled back to the reactor 40. A bottom stream 88 from the partial condenser 84 including the hydrogen iodide, trace amounts of residual unreacted iodine and trace amounts of water may be provided to a product column 90. The product column 90 may be configured for the separation of the residual unreacted iodine, the water and other higher boiling compounds from the hydrogen iodide. A bottom stream 92 of the product column 90 including the unreacted iodine may be recycled back to the iodine liquefier 20. Alternatively, the bottom stream 92 of the product column 90 including the unreacted iodine may be recycled back to the iodine vaporizer 24. The resulting purified hydrogen iodide product may be collected from an overhead stream 94 of the product column 90. A purge stream 96 may be taken from the product column 90 to control the build-up of low boiling impurities. A portion of the purge stream 96 may be recycled back to the reactor 40, while another portion may be disposed of.

While this invention has been described as relative to exemplary designs, the present invention may be further modified within the spirit and scope of this disclosure. Further, this application is intended to cover such departures from the present disclosure as come within known or customary practice in the art to which this invention pertains.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### EXAMPLES

### Example 1: Preparation of Hydrogen Iodide from Hydrogen and Iodine Catalyzed by Nickel Catalysts

In Example 1, the manufacture of hydrogen iodide (HI) from hydrogen (H₂) and elemental iodine (I₂) according to Equation 3 describe above was demonstrated using alumina supported nickel catalysts over a range of reaction conditions. The catalyst in a fixed bed tubular reactor was activated prior to introduction of the mixture of hydrogen gas and iodine vapor into the reactor. The catalyst was activated by purging the catalyst with nitrogen gas, followed by introducing hydrogen gas, heating the reactor to 120° C., holding for two hours, and then ramping up the reactor temperature to 230° C. and holding for an additional hour. The reactor temperature was then adjusted to the desired reaction temperature. A predetermined fixed flow rate of hydrogen was bubbled into an iodine vaporizer which was initially charged with a predetermined amount of solid elemental iodine. The iodine vaporizer temperature was controlled at between 150° C. and 170° C., which generated iodine vapor. The vaporizer temperature and the hydrogen flow rate were adjusted accordingly to attain the desired mole ratio of hydrogen to iodine. The mixture of hydrogen and iodine vapor was fed into the reactor to react in the presence of the catalyst to form hydrogen iodide. The reactor effluent was then passed through a two-stage iodine collector to collect any unreacted iodine in a solid form. Then, the iodine collector effluent stream containing the crude hydrogen iodide product was collected in a dry ice trap. The effluent stream from the dry ice trap was bubbled through a scrubber charged with deionized water to capture residual hydrogen iodide from the unreacted hydrogen gas stream. After a predetermined period, the system was shut down and the iodine vaporizer weight loss and the iodine collector weight gain was measured to calculate the average H₂/I₂ feed molar ratio. Residence time was calculated based on the combined feed rate of hydrogen and iodine, and conversion was calculated based on the amounts of hydrogen iodide collected and iodine fed to the reactor.

All reactions were carried out in the range of 0-5 psig. The runs using a 21 wt. % nickel catalyst on the alumina support (Ni/Al₂O₃) each had a run time of 24 hours. The runs using a 20 wt. % Ni/Al₂O₃ or a 5 wt. % Ni/Al₂O₃ catalyst, each run had a run time of 72 hours. Other reaction conditions are shown in Table 2.

The results for each run are shown in Table 2. As shown in Table 2, with the 21 wt. % nickel catalyst on the alumina support, when the contact time was greater than 7 seconds, the average conversion was greater than 90% and the average productivity was about 35 lb./h/ft³ for reaction temperatures from about 320° C. to about 360° C. While the 20 wt. % nickel catalyst on the alumina support performed slightly better than the 21 wt. % nickel catalyst on the alumina support under comparable reaction conditions, the 5 wt. % nickel catalyst on the alumina support showed much lower activity.

TABLE 2
Summary of Example 1 Data

| | | Vaporizer | I₂ Flow | H₂ Flow | H₂/I₂ | Reactor | Contact | | HI |
|---|---|---|---|---|---|---|---|---|---|
| Run | | Temp. | Rate | Rate | (mole | Temp. | Time | Conv. | Productivity |
| No. | Catalyst | (° C.) | (g/h) | (ml/min) | ratio) | (° C.) | (s) | (%) | (lb/h/ft³) |
| 1 | 21 wt. % | 150 | 12.7 | 60 | 2.99 | 280 | 17.7 | 76.9 | 13.8 |
| 2 | Ni/Al₂0₃ | 150 | 14.3 | 60 | 2.65 | 300 | 16.5 | 88.2 | 17.9 |
| 3 | (44.5 ml) | 160 | 26.6 | 120 | 2.85 | 320 | 8.2 | 89.5 | 33.7 |
| 4 | | 160 | 27.2 | 120 | 2.77 | 340 | 7.8 | 90.0 | 34.8 |
| 5 | | 160 | 28.3 | 120 | 2.69 | 350 | 7.9 | 89.9 | 35.9 |
| 6 | | 160 | 28.5 | 120 | 2.66 | 360 | 7.5 | 92.4 | 37.2 |
| 7 | | 160 | 28.1 | 120 | 2.70 | 370 | 7.4 | 92.0 | 36.5 |
| 8 | | 160 | 28.4 | 120 | 2.68 | 380 | 7.3 | 90.9 | 36.4 |
| 9 | 20 wt. % | 170 | 64.1 | 240 | 2.37 | 330 | 8.6 | 93.8 | 37.8 |
| 10 | Ni/Al₂0₃ | 170 | 60.3 | 240 | 2.52 | 350 | 8.4 | 95.8 | 36.3 |
| | (100 ml) | | | | | | | | |
| 11 | 5 wt. % | 170 | 65.2 | 240 | 2.33 | 350 | 8.3 | 38.4 | 15.7 |
| | Ni/Al₂0₃ | | | | | | | | |
| | (100 ml) | | | | | | | | |

### Example 2: Effect of H₂/I₂ Mole Ratio in the Preparation of Hydrogen Iodide from Hydrogen and Iodine Catalyzed by Nickel Catalysts

In Example 2, the effect of H₂/I₂ mole ratio on HI collection rate was demonstrated using the 21 wt. % Ni/Al₂O₃ catalyst over a range of reaction conditions. The same experimental setup and experimental procedure as described in Example 1 were used in Example 2, with each run having a run time of 24 hours. The HI collection rate was defined as the percentage of HI collected in the dry ice cold trap with respect to the total HI generated. As shown in Table 3, the HI collection rate was above 90% when the H₂/I₂ mole ratio was 2.7 (below 3), however, with increasing the H₂/I₂ mole ratio it decreased dramatically. Without wishing to be bound by any theory, this suggests that the condensation of HI becomes more difficult in the presence of an excessive amount of hydrogen.

TABLE 3
Summary of Example 2 Data

| | I₂ | H₂/I₂ | Reaction | Contact | I₂ | HI | HI |
|---|---|---|---|---|---|---|---|
| | rate | (mole | Temp. | Time | Conv. | Productivity | Collection |
| Catalyst | (g/h) | ratio) | (° C.) | (s) | (%) | (lbs/h/ft³) | Rate (%) |
| 21 wt. % | 28.08 | 2.70 | 370 | 7.4 | 92.0 | 36.5 | 90.7 |
| Ni/Al₂0₃ | 35.46 | 4.28 | 320 | 4.5 | 80.0 | 40.0 | 74.2 |
| (44.5 ml) | 36.35 | 5.92 | 340 | 3.2 | 87.5 | 44.9 | 69.7 |
| | 31.56 | 6.42 | 350 | 3.4 | 95.2 | 42.4 | 54.5 |

### Example 3: In-Situ Preparation of NiI₂/Al₂O₃

In Example 3, a Ni/Al₂O₃ catalyst is converted to a NiI₂/Al₂O₃ catalyst in situ, and the converted catalyst is analyzed to verify and quantify the conversion.

The 20 wt. % Ni/Al₂O₃ catalyst was activated in pure hydrogen before use, to remove an air passivated layer thereby exposing the active nickel phase. More specifically, 100 mL of catalyst were charged to the reactor and purged with nitrogen gas (400 mL/min), at room temperature, for about 30 minutes. Nitrogen gas flow was discontinued and hydrogen gas flow (250 mL/min) started. The catalyst was heated to 120° C., at ramp rate of 3° C./min, and held for 1 h. After the hold, the temperature was ramped (3° C./min) to 230° C. and held for an additional hour. The temperature was then ramped (3° C./min) to predetermined reaction temperature.

Except otherwise stated, all materials were used as obtained without further purification. A predetermined amount of iodine was charged into the vaporizer, evacuated, pulse-purged thrice with nitrogen gas, and heated to a predetermined temperature. Hydrogen gas, at a predetermined flow rate was bubbled through the vaporizer. The effluent stream from the vaporizer was contacted with the Ni/Al₂O₃ catalyst inside the reactor. The effluent stream from the reactor was passed through two consecutive iodine collectors, then two successive product collection cylinders (PCC), followed by a water bubbler and finally through a caustic scrubber (10 wt. % KOH/H₂O). The iodine collectors were maintained at ˜20° C. (by circulating city water though a copper coil wrapped on the body of the collectors) to assure that unreacted iodine in the reactor effluent stream condensed in the collectors. The anhydrous HI in the reactor effluent stream condensed in the PCC, cooled by liquid nitrogen or acetone-dry ice cooling bath. The uncaptured HI from the PCC was captured in the water bubbler as aqueous HI. The effluent stream from the water bubbler, which was predominantly unreacted hydrogen and entrained aqueous HI, was passed through the caustic scrubber, before it was vented.

The weight of the catalyst was found to increase with time on stream (See Table 4 below). The change in weight was highest during the first 300 h on stream during which the weight of catalyst increased by about 82.3%. After 600 h, all metallic nickel on the surface of the catalyst had been converted into NiI₂. This observation was corroborated by equilibrium calculations which revealed that the equilibrium concentration of metallic nickel was infinitesimal.

TABLE 4
Weight Analysis of Catalyst over Time

| Time on stream, h | 0 | 300 | 600* |
|---|---|---|---|
| Weight of catalyst and reactor, g | 856.3 | 914.2 | 917.4 |
| Change in weight of catalyst, g | 70.3 | 128.2 | 131.4 |
| Change in weight of catalyst, g | N/A | 57.9 | 61.1 |
| Change in weight of catalyst, % | N/A | 82.3 | 86.9 |
| Metallic Ni converted to NiI₂, wt % | 0 | 95 | 100.4 |

Catalyst: 20 wt. % Ni/Al₂O₃;
Amount of catalyst charged to reactor: 70.3 g
*Increase in weight is due to I₂ film on inside of 316 L SS end fittings on reactor

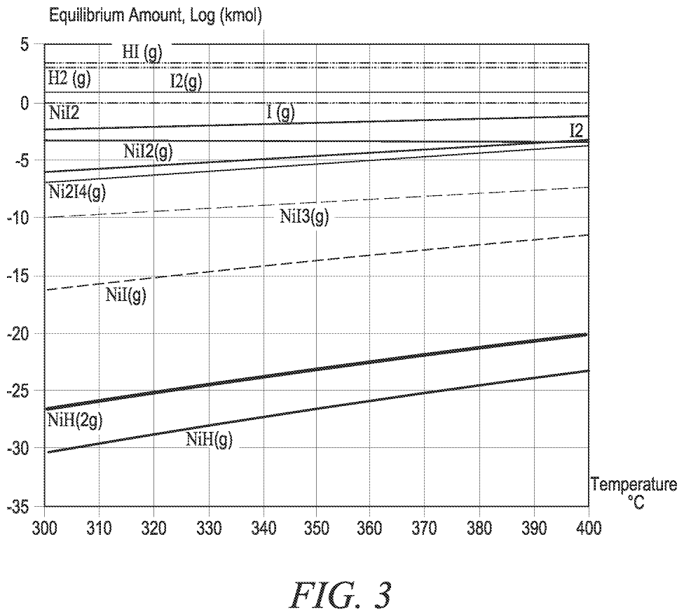

The change in weight of catalyst is due to the formation of nickel (II) iodide (NiI₂), as shown by the equation below. The formation of NiI₂ from metallic nickel and iodine vapors is exothermic and the standard enthalpy of reaction and standard Gibbs Free Energy are −158.8 KJ/mol and −113.8 KJ/mol, respectively. The equilibrium constant at standard conditions is 8.9×10¹⁹. The large equilibrium constant and negative Gibbs Free Energy indicate that the reaction is spontaneous and proceeds readily in the forward direction. This is made possible by the fact that nickel is relatively electropositive compared to other late series metals and can easily loose electron density to form Ni(II) species. FIG. 3 shows the equilibrium concentration of metallic nickel at optimal reaction conditions. As shown, at 350° C., no metallic nickel surface is available.

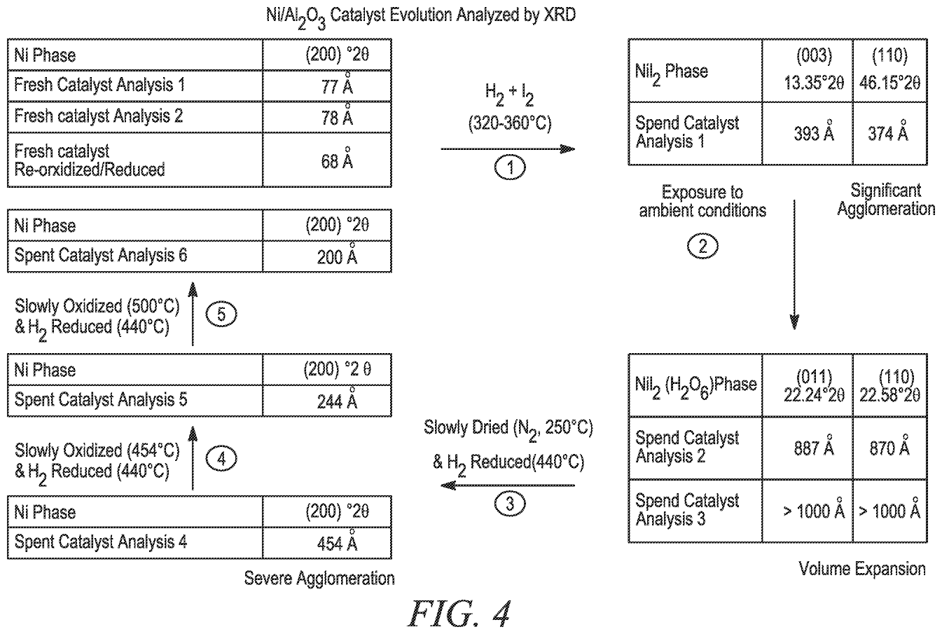

Referring to FIG. 4, The formation of nickel iodide is associated with an increase in particle size. In addition, when exposed to ambient conditions, the nickel iodide reacts with moisture to form a hexa-aqua complex, associated with significant particle agglomeration and volume expansion. For instance, when exposed to ambient conditions, NiI₂/Al₂O₃ catalyst formed a hexa-aqua complex (NiI₂ (H₂O)₆), associated with volume expansion and a loss in catalyst activity. Additionally, the particle size of nickel iodide increased from about 383 Å to ˜1000 Å. When the fresh sample was oxidized followed by reduction, the particle size reduced to ˜68 Å.

Ni₍ₛ₎+I_{2(g)}→NiI₂₍ₛ₎ i.

NiI₂₍ₛ₎+6H₂O_{(g)}→NiI₂(H₂O)₆₍ₛ₎ ii.

NiI₂/NiI₂(H₂O)₆₍ₛ₎+H_{2(g)}→Ni₍ₛ₎+2HI_{(g)}+6H₂O_{(g}) iii.

Although direct reduction of NiI₂ and NiI₂ (H₂O) 6 or mixture of NiI₂/NiI₂ (H₂O) 6 to metallic nickel using hydrogen gas was attained at 440° C., catalyst activity could not be regained. This was attributed to the significant increase in the particle size from 78 Å to ˜454 Å. This indicates that formation of nickel iodide from metallic nickel leads to an increase in the particle size and, exposure of NiI₂/Al₂O₃ to ambient conditions leads to significant agglomeration and volume expansion. In addition, direct reduction of NiI₂/NiI₂ (H₂O)₆ using hydrogen gas is also associated with significant agglomeration. Evidently, the change in particle size has a detrimental impact on catalyst activity. Thus, catalyst regeneration must entail concurrent reduction of nickel iodide particle size and redispersion on the alumina catalyst support. Following the reduction of NiI₂/NiI₂ (H₂O)₆ to metallic nickel; subsequent oxidation at 454° C., to make nickel oxide (NiO) followed by reduction at 440° C. to obtain metallic nickel afforded a particle size of ˜244 Å. Further oxidation at 500° C., followed by reduction at 440° C. resulted in metallic nickel with even smaller particle size of ˜200 Å. Therefore, it's conceivable that with repetitive oxidation and reduction cycles, the large nickel iodide clusters can be converted to smaller metallic nickel particles and re-dispersed on the alumina support.

FIG. 4 shows a diagrammatic representation of the aforementioned process of catalyst use and regeneration with particle size measured by X-Ray diffraction.

Without wishing to be bound to theory, the present inventors believe that deactivated catalyst during the gas phase reaction of hydrogen and iodine vapors to form hydrogen iodide can be regenerated using successive oxidation and reduction, in a three-step process.

NiI₂₍ₛ₎+H_{2(g)}→Ni₍ₛ₎+2HI_{(g)} i.

2Ni₍ₛ₎+O_{2(g)}→2NiO₍ₛ₎ ii.

NiO₍ₛ₎+H_{2(g)}→Ni₍ₛ₎+H₂O_{(g)} iii.

The direct reduction of nickel iodide to metallic iodide in hydrogen allows iodine to be recovered in the form of hydrogen iodide. This step is associated with significant agglomeration leading to formation large nickel particles. In the second step, the metallic nickel is oxidized in oxygen to form nickel oxide. The oxidation may lead to formation of smaller particles and redispersion. In the last step, the nickel oxide is reduced in hydrogen gas to form metallic nickel.

### Example 4: Effect of H₂/I₂ Mole Ratio and Temperature on Iodine Conversion

In this example, the effects of reagent mole ratio and temperature on reagent conversion are demonstrated. 20 wt. % Ni/Al₂O₃ catalyst was activated in pure hydrogen before use, to remove an air passivated layer thereby exposing the active nickel phase. More specifically, 100 mL of catalyst were charged to the reactor and purged with nitrogen gas (400 mL/min), at room temperature, for about 30 minutes. Nitrogen gas flow was discontinued and hydrogen gas flow (250 mL/min) started. The catalyst was heated to 120° C., at ramp rate of 3° C./min, and held for 1 h. After the hold, the temperature was ramped (3° C./min) to 230° C. and held for an additional hour. The temperature was then ramped (3° C./min) to predetermined reaction temperature.

Except otherwise stated, all materials were used as obtained without further purification. A predetermined amount of iodine was charged into the vaporizer, evacuated, pulse-purged thrice with nitrogen gas, and heated to a predetermined temperature. Hydrogen gas, at a predetermined flow rate is bubbled through the vaporizer. The effluent stream from the vaporizer is contacted with the activated catalyst inside the reactor. The effluent stream from the reactor was passed through two consecutive iodine collectors, then two successive product collection cylinders (PCC), followed by a water bubbler and finally through a caustic scrubber (10 wt. % KOH/H₂O). The iodine collectors were maintained at ˜20° C. (by circulating city water though a copper coil wrapped on the body of the collectors) to assure that unreacted iodine in the reactor effluent stream condensed in the collectors. The anhydrous HI in the reactor effluent stream condensed in the PCC, cooled by liquid nitrogen or acetone-dry ice cooling bath. The uncaptured HI from the PCC was captured in the water bubbler as aqueous HI. The effluent stream from the water bubbler, which was predominantly unreacted hydrogen and entrained aqueous HI, was passed through the caustic scrubber, before it was vented.

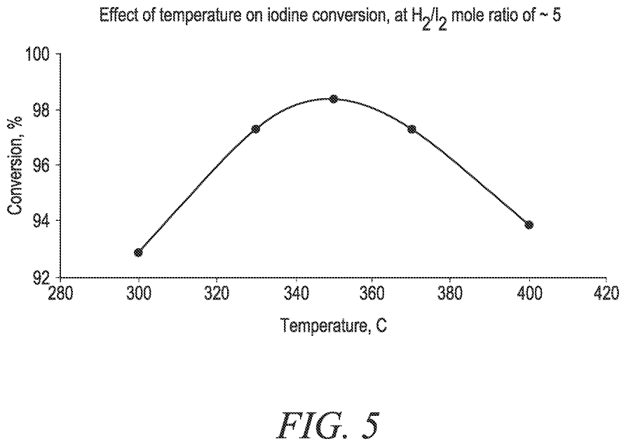

The gas phase reaction of iodine vapors with hydrogen to make hydrogen iodide is exothermic. At equilibrium, lower reaction temperatures will be favor higher iodine conversion. Contrarily, the reverse reaction is endothermic and at high reaction temperatures, will favor decomposition of HI. As demonstrated in Table 7 and FIG. 5, although the gas phase reaction is exothermic, at reaction temperatures <330 deg C. and H₂/I₂ mole ratio ˜5; catalyst activity decreases, and average iodine conversion is <97%. When reaction temperature >370 deg C., it appears the reverse reaction becomes favorable and average iodine conversion <97%. Note that higher reaction temperatures also favor decomposition of HI. Based on these results, when contact time is >8 seconds and H₂/I₂ mole ratio is ˜5; to achieve iodine conversion >98%, the recommended reaction temperature range is from 340-360 deg C.

TABLE 7
Effect of temperature on iodine conversion at high
H2/I2 mole ratio (~5), at low pressure (0-5 psig)

| Temper- | | Contact | H2/I2 | | Produc- | HI |
|---|---|---|---|---|---|---|
| ature, | I2, | time, | mole | Conv, | tivity, | Recovery, |
| C. | g/h | sec | ratio | % | % | % |
| 300 | 113.3 | 10.8 | 5.4 | 92.9 | 16.1 | 78.7 |
| 330 | 124.6 | 10.1 | 4.9 | 97.3 | 17.8 | 81.2 |
| 350 | 124 | 9.8 | 4.9 | 98.4 | 17.8 | 81.3 |
| 370 | 114.7 | 9.6 | 5.3 | 97.3 | 17.3 | 81.3 |
| 400 | 127.1 | 9 | 4.8 | 93.9 | 18.63 | 70.2 |

For the results shown in Table 8 below, the same procedure described earlier was used. 44.5 mL of 20 wt. % Ni/Al₂O₃ catalyst were charged to the reactor at the beginning and the H₂/I₂ mole ratio was adjusted to 2-3.

TABLE 8
Effect of temperature on iodine conversion at high
H2/I2 mole ratio (2-3), at low pressure (0-5 psig)

| I2 | | I2 | H2 | | | | | HI | |
|---|---|---|---|---|---|---|---|---|---|
| Vaporizer | Reaction | flow | flow | Mole | Contact | Time on | I2 | collection | Prod., |
| Temp., | Temp., | rate, | rate, | ratio | time, | stream, | Conv., | rate, | lb/h/ |
| C. | C. | g/h | g/h | H₂/I₂ | s | h | % | % | ft3 |
| 150 | 350 | 13.77 | 0.30 | 2.76 | 15.37 | 24 | 90.54 | 89.75 | 17.61 |
| 150 | 340 | 13.90 | 0.30 | 2.73 | 15.59 | 24 | 89.34 | 89.84 | 17.53 |
| 150 | 330 | 13.63 | 0.30 | 2.79 | 15.93 | 24 | 89.47 | 87.79 | 17.21 |
| 150 | 320 | 14.23 | 0.30 | 2.67 | 16.01 | 24 | 87.24 | 92.44 | 17.53 |
| 150 | 310 | 14.52 | 0.30 | 2.62 | 16.19 | 24 | 89.13 | 89.17 | 18.28 |
| 150 | 300 | 14.34 | 0.30 | 2.65 | 16.53 | 36 | 88.22 | 88.26 | 17.87 |
| 150 | 290 | 13.82 | 0.30 | 2.75 | 16.99 | 24 | 84.18 | 86.80 | 16.43 |
| 150 | 280 | 12.71 | 0.30 | 2.99 | 17.68 | 24 | 76.86 | 63.44 | 13.79 |

### Example 5: Use of Various Catalyst Systems in Conversion of H₂/I₂ to HI

In this example, multiple different combinations of catalysts, supports, and promoters are used to convert hydrogen and iodine into HI. The reaction is run in the same fashion and under the same conditions as any of Examples 1-4. Table 9 below shows possible combinations of catalysts, supports, and optional promoters that are used in the reaction. A catalyst comprises at least one catalyst from column A1 and/or column A2, at least one support from column B, and optionally at least one promoter from column C.

TABLE 9
Catalyst for conversion of H₂ and I₂ to HI

| Column A1: | Column A2: | Column B: | Column C: |
|---|---|---|---|
| Catalyst | Catalyst | Support | Promoter |
| Ni | CuF₂ | Alumina | Zn |
| NiI₂ | CuCl | Carbon | ZnO |
| NiF₂ | CuCl₂ | Silica gel | ZnI₂ |
| NiCl₂ | CuBr | Silicas | ZnF₂ |
| NiBr₂ | CuBr₂ | 3A Zeolite | ZnCl₂ |
| Co | FeI₂ | 4A Zeolite | ZnBr₂ |
| CoI₂ | FeCl₂ | 5A Zeolite | Mn |
| CoF₂ | FeCl₃ | XH-9 Zeolite | MnO |
| CoCl₂ | Cu | 13X Zeolite | MnI₂ |
| CoBr₂ | CuO | Silicon Carbide | MnF₂ |
| Cu₂O | CuI | — | MnCl₂ |
| Mo | W | — | MnBr₂ |
| — | — | — | KI |
| — | — | — | KF |
| — | — | — | KCl |

### Example 6: Preparation of Hydrogen Iodide from Hydrogen and Iodine Catalyzed by Nickel Iodide Catalysts

In this example, the manufacture of hydrogen iodide (HI) from hydrogen (H₂) and elemental iodine (I₂) according to Equation 3 described above is demonstrated using alumina supported nickel iodide catalysts over a range of reaction conditions. The catalyst in a fixed bed tubular reactor is activated prior to introduction of the mixture of hydrogen gas and iodine vapor into the reactor. The catalyst is activated by purging the catalyst with nitrogen gas, followed by introducing hydrogen gas, heating the reactor to 120° C., holding for two hours, and then ramping up the reactor temperature to 230° C. and holding for an additional hour. The reactor temperature is then adjusted to the desired reaction temperature. A predetermined fixed flow rate of hydrogen is bubbled into an iodine vaporizer which is initially charged with a predetermined amount of solid elemental iodine. The iodine vaporizer temperature is controlled at between 150° C. and 170° C., which generates iodine vapor. The vaporizer temperature and the hydrogen flow rate are adjusted accordingly to attain the desired mole ratio of hydrogen to iodine. The mixture of hydrogen and iodine vapor is fed into the reactor to react in the presence of the nickel iodide catalyst to form hydrogen iodide. The reactor effluent is then passed through a two-stage iodine collector to collect any unreacted iodine in a solid form. Then, the iodine collector effluent stream containing the crude hydrogen iodide product is collected in a dry ice trap. The effluent stream from the dry ice trap is bubbled through a scrubber charged with deionized water to capture residual hydrogen iodide from the unreacted hydrogen gas stream. After a predetermined period, the system is shut down and the iodine vaporizer weight loss and the iodine collector weight gain is measured to calculate the average H₂/I₂ feed molar ratio. Residence time is calculated based on the combined feed rate of hydrogen and iodine, and conversion is calculated based on the amounts of hydrogen iodide collected and iodine fed to the reactor.

All reactions are carried out in the range of 0-5 psig. The runs using a 21 wt. % nickel iodide catalyst on the alumina support (NiI₂/Al₂O₃) each have a run time of 24 hours. The runs using a 20 wt. % NiI₂/Al₂O₃ or a 5 wt. % NiI₂/Al₂O₃ catalyst, each run have a run time of 72 hours. Other reaction conditions are shown in Table 10.

The expected results for each run are shown in Table 10. As shown in Table 10, with the 21 wt. % nickel iodide catalyst on the alumina support, when the contact time is greater than 7 seconds, the average conversion is greater than 90% and the average productivity is about 35 lb./h/ft³ for reaction temperatures from about 320° C. to about 360° C. While the 20 wt. % nickel catalyst on the alumina support perform slightly better than the 21 wt. % nickel catalyst on the alumina support under comparable reaction conditions, the 5 wt. % nickel catalyst on the alumina support shows much lower activity.

TABLE 10
Summary of Example 1 Data

| | | Vaporizer | I₂ Flow | H₂ Flow | H₂/I₂ | Reactor | Contact | | HI |
|---|---|---|---|---|---|---|---|---|---|
| Run | | Temp. | Rate | Rate | (mole | Temp. | Time | Conv. | Productivity |
| No. | Catalyst | (° C.) | (g/h) | (ml/min) | ratio) | (° C.) | (s) | (%) | (lb/h/ft³) |
| 1 | 21 wt. % | 150 | 12.7 | 60 | 2.99 | 280 | 17.7 | 76.9 | 13.8 |
| 2 | Ni/Al₂0₃ | 150 | 14.3 | 60 | 2.65 | 300 | 16.5 | 88.2 | 17.9 |
| 3 | (44.5 ml) | 160 | 26.6 | 120 | 2.85 | 320 | 8.2 | 89.5 | 33.7 |
| 4 | | 160 | 27.2 | 120 | 2.77 | 340 | 7.8 | 90.0 | 34.8 |
| 5 | | 160 | 28.3 | 120 | 2.69 | 350 | 7.9 | 89.9 | 35.9 |
| 6 | | 160 | 28.5 | 120 | 2.66 | 360 | 7.5 | 92.4 | 37.2 |
| 7 | | 160 | 28.1 | 120 | 2.70 | 370 | 7.4 | 92.0 | 36.5 |
| 8 | | 160 | 28.4 | 120 | 2.68 | 380 | 7.3 | 90.9 | 36.4 |
| 9 | 20 wt. % | 170 | 64.1 | 240 | 2.37 | 330 | 8.6 | 93.8 | 37.8 |
| 10 | Ni/Al₂0₃ | 170 | 60.3 | 240 | 2.52 | 350 | 8.4 | 95.8 | 36.3 |
| | (100 ml) | | | | | | | | |
| 11 | 5 wt. % | 170 | 65.2 | 240 | 2.33 | 350 | 8.3 | 38.4 | 15.7 |
| | Ni/Al₂0₃ | | | | | | | | |
| | (100 ml) | | | | | | | | |

### ASPECTS

Aspect 1 is a process for producing hydrogen iodide. The process includes providing a vapor-phase reactant stream comprising hydrogen and iodine and reacting the reactant stream in the presence of a nickel iodide catalyst supported on a support to produce a product stream comprising hydrogen iodide.

Aspect 2 is the process of Aspect 1, wherein the support is selected from the group consisting of: alumina, carbon, silica, and zeolites.

Aspect 3 is the process of either Aspect 1 or Aspect 2, further comprising the step of activating a nickel catalyst to form the nickel iodide catalyst.

Aspect 4 is the process of Aspect 3, wherein the activating step comprises contacting the nickel catalyst with iodine vapor.

Aspect 5 is the process of Aspect 3 or Aspect 4, wherein the process is continuous and the reacting step occurs at least partially simultaneously with the activating step.

Aspect 6 is the process of any of Aspects 1-5, further comprising the step of regenerating the nickel iodide catalyst.

Aspect 7 is the process of Aspect 6, wherein the regenerating step comprises reducing the nickel iodide catalyst at least once and oxidizing the nickel iodide catalyst at least once.

Aspect 8 is the process of Aspect 6 or Aspect 7, wherein the regenerating step reduces an average particle size of the nickel iodide catalyst to less than 500 Å.

Aspect 9 is the process of any of Aspects 6-8, wherein the regenerating step comprises drying the catalyst.

Aspect 10 is the process of Aspect 9, wherein the drying step comprises heating the catalyst to a temperature of at least 200° C. in the presence of an inert gas.

Aspect 11 is the process of any of Aspects 6-10, wherein the regenerating step comprises reducing the catalyst a first time.

Aspect 12 is the process of Aspect 11, wherein the regenerating step further comprises oxidizing the catalyst a first time.

Aspect 13 is the process of Aspect 12, wherein the regenerating step further comprises reducing the catalyst a second time.

Aspect 14 is the process of any of Aspects 1-13, wherein the reacting step occurs at a temperature from 300° C. to 400° C., and the ratio of hydrogen to iodine in the vapor-phase reactant stream is from 1:1 to 1:10.

Aspect 15 is the process of any of Aspects 1-14, wherein the nickel iodide catalyst further comprises at least one of cobalt, iron, molybdenum, and tungsten.

Aspect 16 is the process of any of Aspects 1-15, wherein the reacting step occurs at a pressure from 10 kPag to 1500 kPag.

Aspect 17 is the process of any of Aspects 1-16, wherein the product stream further comprises unreacted iodine.

Aspect 18 is the process of Aspect 17, further comprising the additional steps of separating the unreacted iodine from the product stream as solid iodine; heating the solid iodine to produce liquid iodine; and returning the liquid iodine to the reactant stream

Aspect 19 is a process for regenerating a catalyst. The process includes providing a catalyst selected from the group consisting of nickel, cobalt, cobalt halides, iron, nickel oxide, nickel halides, copper, copper oxide, copper halides, cobalt oxide, ferrous chloride, ferric chloride, iron oxide, zinc, zinc oxide, zinc halides, molybdenum, tungsten, magnesium, magnesium oxide, and magnesium halides, wherein the catalyst is supported on a support and is configured to convert hydrogen and iodine into hydrogen iodide. The process also includes drying the catalyst, reducing the catalyst a first time, oxidizing the catalyst a first time, and reducing the catalyst a second time, wherein the process generates a regenerated catalyst with an average particle size less than 800 Å.

Aspect 20 is the process of Aspect 19, further comprising the steps of oxidizing the catalyst a second time, and reducing the catalyst a third time, wherein each reduction and oxidation cycle further reduces the average particle size.

Aspect 21 is the process of Aspect 19 or Aspect 20, wherein the drying step comprises heating the catalyst to a temperature of at least 200° C. in the presence of an inert gas.

Aspect 22 is the process of any of Aspects 19-21, wherein the catalyst is nickel iodide and the support is alumina.

Aspect 23 is the process of Aspect 22, wherein the process at least partially converts the nickel iodide to nickel.

Aspect 24 is the process of any of Aspects 19-23, wherein the regenerated catalyst is configured to be activated and to convert iodine and hydrogen into hydrogen iodide.

Aspect 25 is a process for producing hydrogen iodide comprising providing a vapor-phase reactant stream comprising hydrogen and iodine, and reacting the reactant stream in the presence of a catalyst to produce a product stream comprising hydrogen iodide, wherein the catalyst comprises at least one selected from the group of nickel, cobalt, cobalt halides, iron, nickel oxide, nickel halides, copper, copper oxide, copper halides, cobalt oxide, ferrous chloride, ferric chloride, iron oxide, zinc, zinc oxide, zinc halides, molybdenum, tungsten, magnesium, magnesium oxide, and magnesium halides, and wherein the catalyst is supported on a support.

Aspect 26 is the process of Aspect 25, wherein the support is selected from the group of activated carbon, silica gel, zeolite, silicon carbide, metal oxides, or combinations thereof.

Aspect 27 is the process of Aspect 25 or Aspect 26, wherein the catalyst is selected from the group consisting of nickel and nickel iodide and the support is alumina.

Aspect 28 is the process of any of Aspects 25-27, wherein the catalyst is nickel and the process further comprises the steps of converting at least a portion of the catalyst into nickel iodide; and further reacting the reactant stream in the presence of the nickel iodide.

Aspect 29 is the process of any of Aspects 25-28, wherein the product stream further comprises unreacted iodine and the process further comprises the additional steps of separating the unreacted iodine from the product stream as solid iodine; heating the solid iodine to produce liquid iodine; and returning the liquid iodine to the reactant stream.

Aspect 30 is the process of any of Aspects 25-29, further comprising the step of activating the catalyst.

Aspect 31 is the process of any of Aspects 25-30, further comprising the step of regenerating the catalyst.

Aspect 32 is the process of Aspect 31, wherein the regenerating step comprises reducing the catalyst at least once and oxidizing the catalyst at least once.

Aspect 33 is the process of Aspect 31 or Aspect 32, wherein the regenerating step reduces an average particle size of the catalyst to less than 500 Å.

Aspect 34 is the process of any of Aspects 31-33, wherein the regenerating step comprises drying the catalyst.

Aspect 35 is the process of Aspect 34, wherein the drying step comprises heating the catalyst to a temperature of at least 200° C. in the presence of an inert gas.

Aspect 36 is the process of any of Aspects 31-35, wherein the regenerating step comprises reducing the catalyst a first time.

Aspect 37 is the process of Aspect 36, wherein the regenerating step further comprises oxidizing the catalyst a first time.

Aspect 38 is the process of Aspect 37, wherein the regenerating step further comprises reducing the catalyst a second time.

Aspect 39 is the process of any of Aspects 25-38, wherein the reacting step occurs at a temperature from 300° C. to 400° C., and the ratio of hydrogen to iodine in the vapor-phase reactant stream is from 1:1 to 1:10.

Aspect 40 is the process of any of Aspects 25-39, wherein the catalyst further comprises a second material selected from the group consisting of cobalt, iron, molybdenum, and tungsten.

Aspect 41 is the process of any of Aspects 25-40, wherein the reacting step occurs at a pressure from 10 kPag to 1500 kPag.

What is claimed is:

1. A process for producing hydrogen iodide comprising:
providing a vapor-phase reactant stream comprising hydrogen and iodine; and
reacting the reactant stream in the presence of a nickel iodide catalyst supported on a support to produce a product stream comprising hydrogen iodide.

2. The process of claim 1, wherein the support is selected from the group consisting of: alumina, carbon, silica, and zeolites.

3. The process of claim 1, further comprising the step of activating a nickel catalyst to form the nickel iodide catalyst.

4. The process of claim 3, wherein the activating step comprises contacting the nickel catalyst with iodine vapor.

5. The process of claim 3, wherein the process is continuous and the reacting step occurs at least partially simultaneously with the activating step.

6. The process of claim 1, further comprising the step of regenerating the nickel iodide catalyst.

7. The process of claim 6, wherein the regenerating step comprises reducing the nickel iodide catalyst at least once and oxidizing the nickel iodide catalyst at least once.

8. The process of claim 6, wherein the regenerating step reduces an average particle size of the nickel iodide catalyst to less than 500 Å.

9. The process of claim 1, wherein the reacting step occurs at a temperature from 300° C. to 400° C., and the ratio of hydrogen to iodine in the vapor-phase reactant stream is from 1:1 to 1:10.

10. A process for regenerating a catalyst comprising:
providing a catalyst selected from the group consisting of: nickel, cobalt, cobalt halides, iron, nickel oxide, nickel halides, copper, copper oxide, copper halides, cobalt oxide, ferrous chloride, ferric chloride, iron oxide, zinc, zinc oxide, zinc halides, molybdenum, tungsten, magnesium, magnesium oxide, and magnesium halides, wherein the catalyst is supported on a support and is configured to convert hydrogen and iodine into hydrogen iodide;
drying the catalyst;
reducing the catalyst a first time;
oxidizing the catalyst a first time; and
reducing the catalyst a second time, wherein the process generates a regenerated catalyst with an average particle size less than 800 Å.

11. The process of claim 10, further comprising the steps of:
oxidizing the catalyst a second time; and
reducing the catalyst a third time, wherein each reduction and oxidation cycle further reduces the average particle size.

12. The process of claim 10, wherein the drying step comprises heating the catalyst to a temperature of at least 200° C. in the presence of an inert gas.

13. The process of claim 10, wherein the catalyst is nickel iodide and the support is alumina.

14. The process of claim 13, wherein the process at least partially converts the nickel iodide to nickel.

15. A process for producing hydrogen iodide comprising:
providing a vapor-phase reactant stream comprising hydrogen and iodine; and
reacting the reactant stream in the presence of a catalyst to produce a product stream comprising hydrogen iodide, wherein the catalyst comprises at least one selected from the group of nickel, cobalt, cobalt halides, iron, nickel oxide, nickel halides, copper, copper oxide, copper halides, cobalt oxide, ferrous chloride, ferric chloride, iron oxide, zinc, zinc oxide, zinc halides, molybdenum, tungsten, magnesium, magnesium oxide, and magnesium halides, and wherein the catalyst is supported on a support.
